(19) United States
(12) Patent Application Publication
(10) Pub. No.: US 2026/0304420 A1
(43) Pub. Date: Oct. 1, 2026

(54) METHOD AND DEVICE FOR TRANSMISSION AND RECEPTION OF UPLINK SIGNAL

(71) Applicant: SAMSUNG ELECTRONICS CO., LTD., Suwon-si, Gyeonggi-do (KR)

(72) Inventors: Sa ZHANG, Beijing (CN); Feifei SUN, Beijing (CN); Zhe CHEN, Beijing (CN)

(21) Appl. No.: 19/472,579

(22) PCT Filed: Mar. 26, 2024
(86) PCT No.: PCT/KR2024/003767

§ 371 Date: Oct. 3, 2025

(30) Foreign Application Priority Data
Apr. 4, 2023 (CN) 202310358168.9
Oct. 7, 2023 (CN) 202311287471.0

(51) Int. Cl. H04W 72/1268; H04L 5/00; H04W 80/02

(52) U.S. Cl. CPC H04W 72/1268; H04L 5/0044; H04W 80/02

(57) ABSTRACT

The disclosure relates to a 5G or 6G communication system for supporting a higher data transmission rate. A method performed by a terminal in a wireless communication system is provided. The method comprises receiving, from a base station, information associated with a configured grant (CG) physical uplink shared channel (PUSCH), identifying that at least one occasion for the CG PUSCH is unused among one or more occasions for the CG PUSCH based on the information associated with the CG PUSCH and transmitting, to the base station, the CG PUSCH including information associated with the at least one occasion.

### TECHNICAL FIELD

The disclosure relates to wireless communication technology, and more particularly, to a method and an apparatus for transmission and reception of uplink signal in a wireless communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Solution to Problem

A method performed by a terminal in a wireless communication system is provided. The method comprises receiving, from a base station, information associated with a configured grant (CG) physical uplink shared channel (PUSCH), identifying that at least one occasion for the CG PUSCH is unused among one or more occasions for the CG PUSCH based on the information associated with the CG PUSCH and transmitting, to the base station, the CG PUSCH including information associated with the at least one occasion.

A terminal in a wireless communication system is provided. The terminal comprises a transceiver and a controller coupled with the transceiver and configured to receive, from a base station, information associated with a configured grant (CG) physical uplink shared channel (PUSCH), identify that at least one occasion for the CG PUSCH is unused among one or more occasions for the CG PUSCH based on the information associated with the CG PUSCH, and transmit, to the base station, the CG PUSCH including information associated with the at least one occasion.

A method perform by a base station in a wireless communication system is provided. The method comprises transmitting, to a terminal, information associated with configured grant (CG) physical uplink shared channel (PUSCH) and receiving, from the terminal, the CG PUSCH including information associated with at least one occasion for the CG PUSCH among one or more occasions for the CG PUSCH, wherein the one or more occasions are based on the information associated with the CG PUSCH, and wherein at least one CG PUSCH is not received from the terminal in the at least one occasion.

A base station in a wireless communication system is provided. The base station comprises a transceiver and a controller coupled with the transceiver and configured to transmit, to a terminal, information associated with configured grant (CG) physical uplink shared channel (PUSCH), and receive, from the terminal, the CG PUSCH including information associated with at least one occasion for the CG PUSCH among one or more occasions for the CG PUSCH, wherein the one or more occasions are based on the information associated with the CG PUSCH, and wherein at least one CG PUSCH is not received from the terminal in the at least one occasion.

### BRIEF DESCRIPTION OF DRAWINGS

In order to illustrate the technical schemes of the embodiments of the disclosure more clearly, the drawings of the embodiments of the disclosure will be briefly introduced below. Apparently, the drawings described below only refer to some embodiments of the disclosure, and do not limit the disclosure, in which:

FIG. 1 illustrates a schematic diagram of an example wireless network according to some embodiments of the disclosure;

FIG. 2A illustrates an example of wireless transmission and reception paths according to some embodiments of the disclosure

FIG. 2B illustrates an example of wireless transmission and reception paths according to some embodiments of the disclosure;

FIG. 3A illustrates an example user equipment (UE) according to some embodiments of the disclosure;

FIG. 3B illustrates an example gNB according to some embodiments of the disclosure;

FIG. 4 illustrates a block diagram of a first transceiving node according to some embodiments of the disclosure;

FIG. 5 illustrates a block diagram of a second transceiving node according to some embodiments of the disclosure;

FIG. 6 illustrates a flowchart of a method performed by a base station according to some embodiments of the disclosure;

FIG. 7 illustrates a flowchart of a method performed by a UE according to some embodiments of the disclosure;

FIGS. 8A-8C illustrate some examples of uplink transmission timing according to some embodiments of the disclosure;

FIGS. 9A and 9B illustrate examples of time domain resource allocation tables according to some embodiments of the disclosure;

FIG. 10 illustrates a flowchart of a method performed by a terminal according to some embodiments of the disclosure; and

FIG. 11 illustrates a flowchart of a method performed by a base station according to some embodiments of the disclosure.

### BEST MODE FOR CARRYING OUT THE INVENTION

In order to make the purpose, technical schemes and advantages of the embodiments of the disclosure clearer, the technical schemes of the embodiments of the disclosure will be described clearly and completely with reference to the drawings of the embodiments of the disclosure. Apparently, the described embodiments are a part of the embodiments of the disclosure, but not all embodiments. Based on the described embodiments of the disclosure, all other embodiments obtained by those of ordinary skill in the art without creative labor belong to the protection scope of the disclosure.

Before undertaking the DETAILED DESCRIPTION below, it can be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, connect to, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller can be implemented in hardware or a combination of hardware and software and/or firmware. The functionality associated with any particular controller can be centralized or distributed, whether locally or remotely. The phrase “at least one of,” when used with a list of items, means that different combinations of one or more of the listed items can be used, and only one item in the list can be needed. For example, “at least one of: A, B, and C” includes any of the following combinations: A, B, C, A and B, A and C, B and C, and A and B and C. For example, “at least one of: A, B, or C” includes any of the following combinations: A, B, C, A and B, A and C, B and C, and A, B and C.

Moreover, various functions described below can be implemented or supported by one or more computer programs, each of which is formed from computer-readable program code and embodied in a computer-readable medium. The terms “application” and “program” refer to one or more computer programs, software components, sets of instructions, procedures, functions, objects, classes, instances, related data, or a portion thereof adapted for implementation in a suitable computer-readable program code. The phrase “computer-readable program code” includes any type of computer code, including source code, object code, and executable code. The phrase “computer-readable medium” includes any type of medium capable of being accessed by a computer, such as Read-Only Memory (ROM), Random Access Memory (RAM), a hard disk drive, a Compact Disc (CD), a Digital Video Disc (DVD), or any other type of memory. A “non-transitory” computer-readable medium excludes wired, wireless, optical, or other communication links that transport transitory electrical or other signals. A non-transitory computer-readable medium includes media where data can be permanently stored and media where data can be stored and later overwritten, such as a rewritable optical disc or an erasable memory device.

Terms used herein to describe the embodiments of the disclosure are not intended to limit and/or define the scope of the present invention. For example, unless otherwise defined, the technical terms or scientific terms used in the disclosure shall have the ordinary meaning understood by those with ordinary skills in the art to which the present invention belongs.

It should be understood that “first”, “second” and similar words used in the disclosure do not express any order, quantity or importance, but are only used to distinguish different components. Similar words such as singular forms “a”, “an” or “the” do not express a limitation of quantity, but express the existence of at least one of the referenced item, unless the context clearly dictates otherwise. For example, reference to “a component surface” includes reference to one or more of such surfaces.

As used herein, any reference to “an example” or “example”, “an implementation” or “implementation”, “an embodiment” or “embodiment” means that particular elements, features, structures or characteristics described in connection with the embodiment is included in at least one embodiment. The phrases “in one embodiment” or “in one example” appearing in different places in the specification do not necessarily refer to the same embodiment.

As used herein, “a portion of” something means “at least some of” the thing, and as such may mean less than all of, or all of, the thing. As such, “a portion of” a thing includes the entire thing as a special case, i.e., the entire thing is an example of a portion of the thing.

As used herein, the term “set” means one or more. Accordingly, a set of items can be a single item or a collection of two or more items.

In the disclosure, to determine whether a specific condition is satisfied or fulfilled, expressions, such as “greater than/larger than” or “less than/smaller than” are used by way of example and expressions, such as “greater than or equal to” or “less than or equal to” are also applicable and not excluded. For example, a condition defined with “greater than or equal to” may be replaced by “greater than” (or vice-versa), a condition defined with “less than or equal to” may be replaced by “less than” (or vice-versa), etc.

It will be further understood that similar words such as the term “include” or “comprise” mean that elements or objects appearing before the word encompass the listed elements or objects appearing after the word and their equivalents, but other elements or objects are not excluded. Similar words such as “connect” or “connected” are not limited to physical or mechanical connection, but can include electrical connection, whether direct or indirect. “Upper”, “lower”, “left” and “right” are only used to express a relative positional relationship, and when an absolute position of the described object changes, the relative positional relationship may change accordingly.

The various embodiments discussed below for describing the principles of the disclosure in the patent document are for illustration only and should not be interpreted as limiting the scope of the disclosure in any way. Those skilled in the art will understand that the principles of the disclosure can be implemented in any suitably arranged wireless communication system. For example, although the following detailed description of the embodiments of the disclosure will be directed to LTE and/or 5G communication systems, those skilled in the art will understand that the main points of the disclosure can also be applied to other communication systems with similar technical backgrounds and channel formats with slight modifications without departing from the scope of the disclosure. The technical schemes of the embodiments of the present application can be applied to various communication systems, and for example, the communication systems may include global systems for mobile communications (GSM), code division multiple access (CDMA) systems, wideband code division multiple access (WCDMA) systems, general packet radio service (GPRS) systems, long term evolution (LTE) systems, LTE frequency division duplex (FDD) systems, LTE time division duplex (TDD) systems, universal mobile telecommunications system (UMTS), worldwide interoperability for microwave access (WiMAX) communication systems, 5th generation (5G) systems or new radio (NR) systems, etc. In addition, the technical schemes of the embodiments of the present application can be applied to future-oriented communication technologies.

Hereinafter, the embodiments of the disclosure will be described in detail with reference to the accompanying drawings. It should be noted that the same reference numerals in different drawings will be used to refer to the same elements already described.

The text and drawings are provided as examples only to help readers understand the disclosure. They are not intended and should not be interpreted as limiting the scope of the disclosure in any way. Although certain embodiments and examples have been provided, based on the content disclosed herein, it will be apparent to those skilled in the art that changes may be made to the illustrated embodiments and examples without departing from the scope of the disclosure.

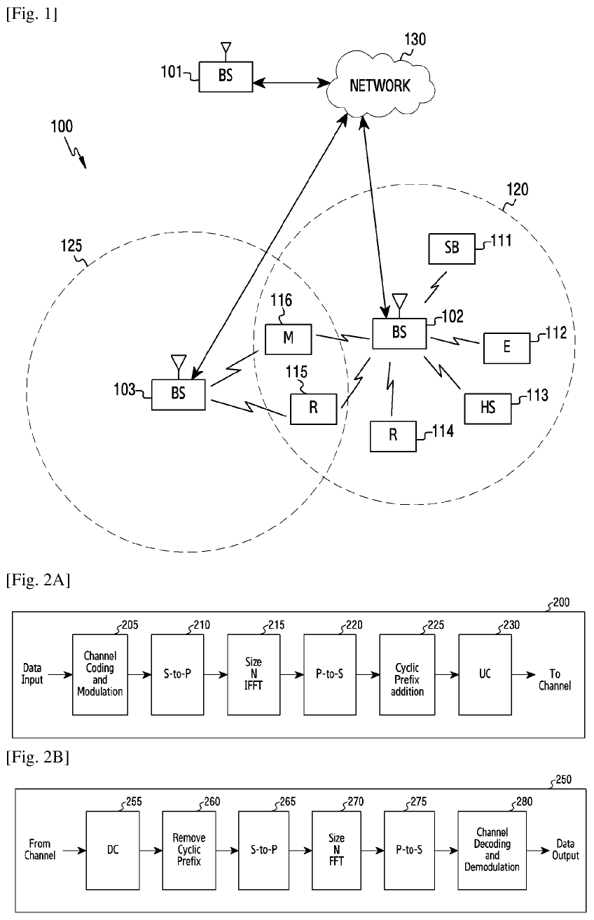

The following FIGS. 1-3B describe various embodiments implemented by using orthogonal frequency division multiplexing (OFDM) or orthogonal frequency division multiple access (OFDMA) communication technologies in wireless communication systems. The descriptions of FIGS. 1-3B do not mean physical or architectural implications for the manner in which different embodiments may be implemented. Different embodiments of the disclosure may be implemented in any suitably arranged communication systems.

In order to meet the increasing demand for wireless data communication services since the deployment of 4G communication systems, efforts have been made to develop improved 5G or pre-5G communication systems. Therefore, 5G or pre-5G communication systems are also called “Beyond 4G networks” or “Post-LTE systems”.

In order to achieve a higher data rate, 5G communication systems are implemented in higher frequency (millimeter, mmWave) bands, e.g., 60 GHz bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, etc.

In 5G systems, hybrid FSK and QAM modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

According to at least one embodiment of the disclosure, there is provided a method performed by a terminal in a wireless communication system. The method includes: receiving second information, wherein the second information is used to indicate information related to configured grant (CG) physical uplink shared channel (PUSCH) transmission occasions; determining third information based on the second information, wherein the third information includes whether one or more CG PUSCH transmission occasions are unused; and transmitting a CG PUSCH with fourth information, wherein the fourth information indicates information related to unused CG PUSCH transmission occasions among the one or more CG PUSCH transmission occasions.

In combination with one or more aspects of the method performed by the terminal described above, for example, the method further includes receiving first information, wherein the first information is used to enable the terminal to report the fourth information.

In combination with one or more aspects of the method performed by the terminal described above, for example, the one or more CG PUSCH transmission occasions correspond to a first logical channel, wherein the first information is used to enable the terminal to report the fourth information for CG PUSCH configurations in a CG list allowed for the first logical channel.

In combination with one or more aspects of the method performed by the terminal described above, for example, determining the third information includes determining a number of used CG PUSCH transmission occasions among the one or more CG PUSCH transmission occasions.

In combination with one or more aspects of the method performed by the terminal described above, for example, determining the third information includes determining available CG PUSCH transmission occasions among the one or more CG PUSCH transmission occasions.

In combination with one or more aspects of the method performed by the terminal described above, for example, the one or more CG PUSCH transmission occasions correspond to a first logical channel, wherein determining the third information includes, for the one or more CG PUSCH transmission occasions, determining the third information based on one or more of a size of a media access control (MAC) protocol data unit (PDU) that can be carried by the CG PUSCH transmission occasion, the second information, and a size of a packet of the first logical channel.

In combination with one or more aspects of the method performed by the terminal described above, for example, the one or more CG PUSCH transmission occasions correspond to a first logical channel, wherein determining the third information includes determining a first unused CG PUSCH transmission occasion in the first logical channel.

In combination with one or more aspects of the method performed by the terminal described above, for example, the first unused CG PUSCH transmission occasion in the first logical channel is determined based on one or more of: the second information; sixth information, wherein the sixth information is used to indicate information related to an amount of data of the first logical channel; second time information, wherein the second time information is used to indicate information related to a time interval between a first CG PUSCH transmission occasion and the first unused CG PUSCH transmission occasion in the first logical channel; seventh information, wherein the seventh information is used to indicate information related to a number of CG PUSCH transmission occasions between an earliest CG PUSCH transmission occasion and the first unused CG PUSCH transmission occasion in the first logical channel; a number of repetitions of a CG PUSCH; a number of CG PUSCH transmission occasions in a CG PUSCH period; a size of a MAC control element (CE) transmitted by a CG PUSCH; at least one of a time domain resource, a frequency domain resource, a resource block group (RBG) size, a modulation and coding scheme (MCS) table, or a MCS and a transport block size (TBS) for a CG PUSCH configuration; a size of a MAC PDU that can be carried by the CG PUSCH transmission occasion; a CG timer associated with a HARQ process for a CG PUSCH configuration; or available CG PUSCH transmission occasions.

In combination with one or more aspects of the method performed by the terminal described above, for example, the one or more CG PUSCH transmission occasions correspond to a first logical channel, wherein the second information indicates one or more of: whether a MAC CE can be multiplexed in a CG PUSCH; whether a MAC CE can be multiplexed in a predefined CG PUSCH; a maximum number of MAC CEs that can be included in a CG PUSCH; whether data of a second logical channel can be multiplexed in a CG PUSCH; whether data of the second logical channel can be multiplexed in the predefined CG PUSCH; or a maximum value of an amount of data of the second logical channel that can be included in a CG PUSCH.

In combination with one or more aspects of the method performed by the terminal described above, for example, the predefined CG PUSCH is a CG PUSCH other than the first CG PUSCH in the first logical channel.

According to at least one embodiment of the disclosure, there is provided a method performed by a base station in a wireless communication system. The method includes: transmitting second information to a terminal, wherein the second information is used to indicate information related to configured grant (CG) physical uplink shared channel (PUSCH) transmission occasions; and receiving a CG PUSCH with fourth information from the terminal, wherein the fourth information indicates information related to unused CG PUSCH transmission occasions among one or more CG PUSCH transmission occasions, wherein the fourth information is determined based on third information, wherein the third information is determined based on the second information, wherein the third information includes whether the one or more CG PUSCH transmission occasions are unused.

In combination with one or more aspects of the method performed by the base station described above, for example, the method further includes transmitting first information, wherein the first information is used to enable the terminal to report fourth information.

In combination with one or more aspects of the method performed by the base station described above, for example, the one or more CG PUSCH transmission occasions correspond to a first logical channel, wherein the first information is used to enable the terminal to report the fourth information for CG PUSCH configurations in a CG list allowed for the first logical channel.

In combination with one or more aspects of the method performed by the base station described above, for example, the third information includes a number of used CG PUSCH transmission occasions among the one or more CG PUSCH transmission occasions.

In combination with one or more aspects of the method performed by the base station described above, for example, the third information includes available CG PUSCH transmission occasions among the one or more CG PUSCH transmission occasions.

In combination with one or more aspects of the method performed by the base station described above, for example, the one or more CG PUSCH transmission occasions correspond to a first logical channel, wherein the third information is determined based on one or more of a size of a media access control (MAC) protocol data unit (PDU) that can be carried by the CG PUSCH transmission occasion, the second information, and a size of a packet of the first logical channel.

In combination with one or more aspects of the method performed by the base station described above, for example, the one or more CG PUSCH transmission occasions correspond to a first logical channel, wherein the third information includes a first unused CG PUSCH transmission occasion in the first logical channel.

In combination with one or more aspects of the method performed by the base station described above, for example, the first unused CG PUSCH transmission occasion in the first logical channel is determined based on one or more of: the second information; sixth information, wherein the sixth information is used to indicate information related to an amount of data of the first logical channel; second time information, wherein the second time information is used to indicate information related to a time interval between a first CG PUSCH transmission occasion and the first unused CG PUSCH transmission occasion in the first logical channel; seventh information, wherein the seventh information is used to indicate information related to a number of CG PUSCH transmission occasions between an earliest CG PUSCH transmission occasion and the first unused CG PUSCH transmission occasion in the first logical channel; a number of repetitions of a CG PUSCH; a number of CG PUSCH transmission occasions in a CG PUSCH period; a size of a MAC control element (CE) transmitted by a CG PUSCH; at least one of a time domain resource, a frequency domain resource, a resource block group (RBG) size, a modulation and coding scheme (MCS) table, or a MCS and a transport block size (TBS) for a CG PUSCH configuration; a size of a MAC PDU that can be carried by the CG PUSCH transmission occasion; a CG timer associated with a HARQ process for a CG PUSCH configuration; or available CG PUSCH transmission occasions.

In combination with one or more aspects of the method performed by the base station described above, for example, the one or more CG PUSCH transmission occasions correspond to a first logical channel, wherein the second information indicates one or more of: whether a MAC CE can be multiplexed in a CG PUSCH; whether a MAC CE can be multiplexed in a predefined CG PUSCH; a maximum number of MAC CEs that can be included in a CG PUSCH; whether data of a second logical channel can be multiplexed in a CG PUSCH; whether data of the second logical channel can be multiplexed in the predefined CG PUSCH; or a maximum value of an amount of data of the second logical channel that can be included in a CG PUSCH.

In combination with one or more aspects of the method performed by the base station described above, for example, the predefined CG PUSCH is a CG PUSCH other than the first CG PUSCH in the first logical channel.

According to at least one embodiment of the disclosure, there is also provided a terminal in a wireless communication system. The terminal includes a transceiver, and a controller coupled with the transceiver and configured to perform one or more aspects of the method performed by the terminal.

According to at least one embodiment of the disclosure, there is also provided a base station in a wireless communication system. The base station includes a transceiver, and a controller coupled with the transceiver and configured to perform one or more aspects of the method performed by the base station.

According to at least one embodiment of the disclosure, there is also provided a computer-readable storage medium on which one or more computer programs are stored, wherein one or more aspects of the methods described above can be implemented when the one or more computer programs are executed by one or more processors.

FIG. 1 illustrates an example wireless network 100 according to some embodiments of the disclosure. The embodiment of the wireless network 100 shown in FIG. 1 is for illustration only. Other embodiments of the wireless network 100 can be used without departing from the scope of the disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station (BS)” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For example, the terms “terminal”, “user equipment” and “UE” may be used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

FIGS. 2A and 2B illustrate example wireless transmission and reception paths according to some embodiments of the disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time domain output signal. The Parallel-to-Serial block 220 converts (such as multiplexes) parallel time domain output symbols from the Size N IFFT block 215 to generate a serial time domain signal. The cyclic prefix addition block 225 inserts a cyclic prefix into the time domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time domain baseband signal. The Serial-to-Parallel block 265 converts the time domain baseband signal into a parallel time domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

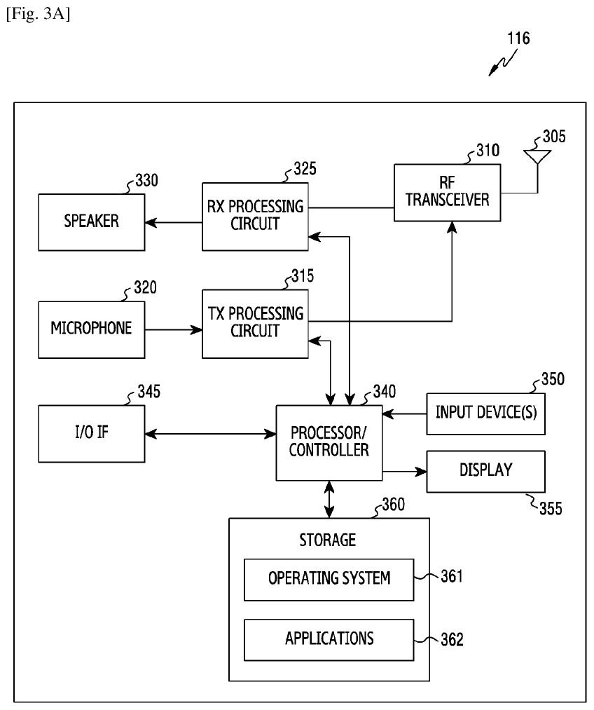

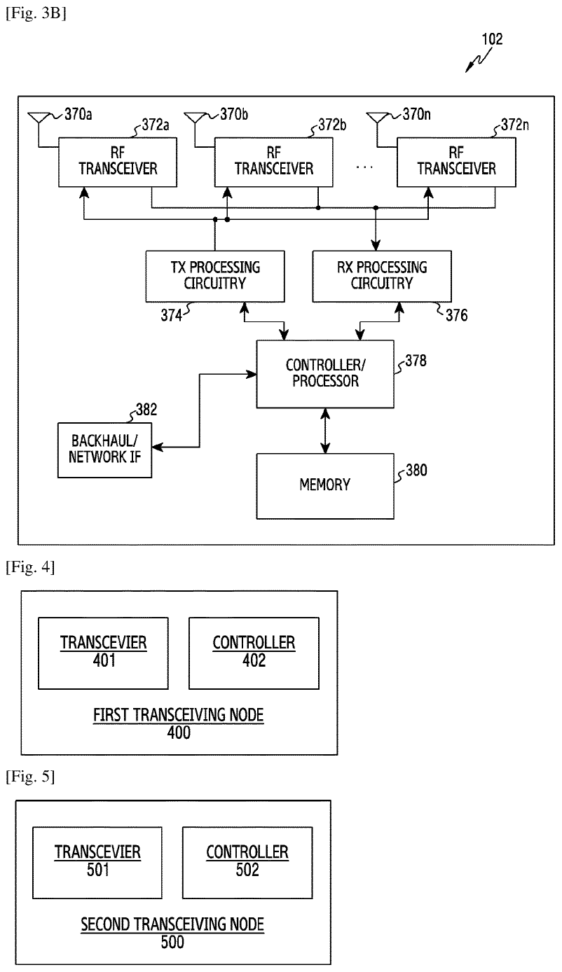

FIG. 3A illustrates an example UE 116 according to some embodiments of the disclosure. The embodiment of UE 116 shown in FIG. 3A is for illustration only, and UEs 111-115 of FIG. 1 can have the same or similar configuration. However, a UE has various configurations, and FIG. 3A does not limit the scope of the disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

In some implementations, two or more UEs 116 may communicate directly using one or more sidelink channels (for example, without using a base station as a medium for communication with each other). For example, the UE 116 may communicate using peer-to-peer (P2P) communication, device-to-device (D2D) communication, vehicle-to-everything (V2X) protocol (which, for example, may include vehicle-to-vehicle (V2V) protocol, vehicle-to-infrastructure (V2I) protocol, etc.), mesh network, etc. In this case, the UE 116 may perform scheduling operations, resource selection operations, and/or other operations performed by the base station as described elsewhere herein. For example, the base station may configure the UE 116 via downlink control information (DCI), radio resource control (RRC) signaling, medium access control-control element (MAC-CE) or via system information (e.g., system information block (SIB)).

FIG. 3B illustrates an example gNB 102 according to some embodiments of the disclosure. The embodiment of gNB 102 shown in FIG. 3B is for illustration only, and other gNBs of FIG. 1 can have the same or similar configuration. However, a gNB has various configurations, and FIG. 3B does not limit the scope of the disclosure to any specific implementation of a gNB. It should be noted that gNB 101 and gNB 103 can include the same or similar structures as gNB 102.

As shown in FIG. 3B, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3B illustrates an example of gNB 102, various changes may be made to FIG. 3B. For example, gNB 102 can include any number of each component shown in FIG. 3A. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

Those skilled in the art will understand that, “terminal” and “terminal device” as used herein include not only devices with wireless signal receiver which have no transmitting capability, but also devices with receiving and transmitting hardware which can carry out bidirectional communication on a bidirectional communication link. Such devices may include cellular or other communication devices with single-line displays or multi-line displays or cellular or other communication devices without multi-line displays; a PCS (personal communications service), which may combine voice, data processing, fax and/or data communication capabilities; a PDA (Personal Digital Assistant), which may include a radio frequency receiver, a pager, an internet/intranet access, a web browser, a notepad, a calendar and/or a GPS (Global Positioning System) receiver; a conventional laptop and/or palmtop computer or other devices having and/or including a radio frequency receiver. “Terminal” and “terminal device” as used herein may be portable, transportable, installed in vehicles (aviation, sea transportation and/or land), or suitable and/or configured to operate locally, and/or in distributed form, operate on the earth and/or any other position in space. “Terminal” and “terminal device” as used herein may also be a communication terminal, an internet terminal, a music/video playing terminal, such as a PDA, a MID (Mobile Internet Device) and/or a mobile phone with music/video playing functions, a smart TV, a set-top box and other devices.

With the rapid development of information industry, especially the increasing demand from mobile Internet and internet of things (IoT), it brings unprecedented challenges to the future mobile communication technology. In order to meet the unprecedented challenges, the communication industry and academia have carried out extensive research on the fifth generation (5G) mobile communication technology to face the 2020s. At present in ITU report ITU-R M.[IMT.VISION], the framework and overall goals of the future 5G has been discussed, in which the demand outlook, application scenarios and important performance indicators of 5G are described in detail. With respect to new requirements in 5G, ITU report ITU-R M.[IMT.FUTURE TECHNOLOGY TRENDS] provides information related to the technology trends of 5G, aiming at solving significant problems such as significantly improved system throughput, consistent user experience, scalability to support IoT, delay, energy efficiency, cost, network flexibility, support of emerging services and flexible spectrum utilization. In 3GPP (3rd Generation Partnership Project), the first stage of 5G is already in progress. To support more flexible scheduling, the 3GPP decides to support variable hybrid automatic repeat request-acknowledgement (HARQ-ACK) feedback delay in 5G. In existing Long Term Evolution (LTE) systems, a time from reception of downlink data to uplink transmission of HARQ-ACK is fixed. For example, in Frequency Division Duplex (FDD) systems, the delay is 4 subframes. In Time Division Duplex (TDD) systems, a HARQ-ACK feedback delay is determined for a corresponding downlink subframe based on an uplink and downlink configuration. In 5G systems, whether FDD or TDD systems, for a determined downlink time unit (for example, a downlink slot or a downlink mini slot; for another example, a PDSCH time unit), the uplink time unit (for example, a PUCCH time unit) that can feedback HARQ-ACK is variable. For example, the delay of HARQ-ACK feedback can be dynamically indicated by physical layer signaling, or different HARQ-ACK delays can be determined based on factors such as different services or user capabilities.

The 3GPP has defined three directions of 5G application scenarios-eMBB (enhanced mobile broadband), mMTC (massive machine-type communication) and URLLC (ultra-reliable and low-latency communication). The eMBB scenario aims to further improve data transmission rate on the basis of the existing mobile broadband service scenario, so as to enhance user experience and pursue ultimate communication experience between people. mMTC and URLLC are, for example, the application scenarios of the Internet of Things, but their respective emphases are different: mMTC being mainly information interaction between people and things, while URLLC mainly reflecting communication requirements between things.

In some cases, in order to reduce the latency, the base station may configure CG (configured grant) PUSCH resources for the UE. Before receiving the CG PUSCHs, the base station is not sure whether a CG PUSCH resource is used by the UE, and the base station cannot allocate a CG PUSCH resource that is unused by the UE to other UEs in advance, which may cause a waste of time-frequency resources. Therefore, an enhanced UE downlink signal receiving method or uplink signal transmitting method is needed to improve the system spectrum efficiency.

In order to at least solve the above technical problems, example embodiments of the disclosure provide a method performed by a terminal, a terminal, a method performed by a base station, a base station and a non-transitory computer-readable storage medium in a wireless communication system. Hereinafter, various embodiments of the disclosure will be described in detail with reference to the accompanying drawings.

In the example embodiments of the disclosure, for the convenience of description, a first transceiving node and a second transceiving node are defined. For example, the first transceiving node may be a base station, and the second transceiving node may be a UE. For another example, the example embodiments of the disclosure may be applicable to the scenario of sidelink communication, in which case, the first transceiving node may be a UE, and the second transceiving node may be another UE. Therefore, the first transceiving node and the second transceiving node may each be any suitable communication node. In the following description, the base station is taken as an example (but not limited thereto) to illustrate the first transceiving node, and the UE is taken as an example (but not limited thereto) to illustrate the second transceiving node.

In describing a wireless communication system and in the disclosure described below, transferring methods (or configuration methods) of higher layer signaling or higher layer signals may be signal transferring methods for transferring information from a base station to a terminal over a downlink data channel of a physical layer or from a terminal to a base station over an uplink data channel of a physical layer, and examples of the signal transferring methods may include signal transferring methods for transferring information via Radio Resource Control (RRC) signaling, Packet Data Convergence Protocol (PDCP) signaling, or a Medium Access Control (MAC) Control Element (CE).

In the following description of the example embodiments of the disclosure, higher layer signaling may be signaling corresponding to at least one or a combination of one or more of the following signaling.
MIB (master information block)
SIB (system information block) or SIB X (X=1, 2, . . . )
RRC signaling
MAC CE

Physical layer (Layer 1 (L1)) signaling may be signaling corresponding to at least one or a combination of one or more of the following signaling.
PDCCH (physical downlink control channel)
DCI (downlink control information)
UE-specific DCI
group common DCI
common DCI (e.g., multicast DCI)
scheduling DCI (for example, DCI for scheduling downlink or uplink data)
non-scheduling DCI (for example, DCI other than DCI for scheduling downlink or uplink data)
PUCCH (physical uplink control channel)
UCI (uplink control information)
Paging
PRACH (physical random access channel)
RAR (random access response)

In the example embodiments of the disclosure, uplink control signaling may include physical layer signaling and/or higher layer signaling. As described above, the physical layer signaling may include UCI and/or PUCCH, and the higher layer signaling may include RRC signaling and/or a MAC CE.

In the example embodiments of the disclosure, downlink control signaling may include physical layer signaling and/or higher layer signaling. As mentioned above, the physical layer signaling may include one or more of PDCCH, DCI, UE-specific DCI, group common DCI, common DCI, scheduling DCI (for example, DCI for scheduling downlink or uplink data), non-scheduling DCI, paging, and RAR, and the higher layer signaling may include one or more of a MIB, a SIB or SIB X (X=1, 2, . . . ), RRC signaling or a MAC CE. Therefore, “configuring or indicating X through downlink control signaling” will be understood as configuring or indicating X through physical layer signaling, or configuring or indicating X through higher layer signaling, or configuring or indicating X through a combination of higher layer signaling and physical layer signaling.

FIG. 4 illustrates a block diagram of a first transceiving node 400 according to some example embodiments of the disclosure.

Referring to FIG. 4, the first transceiving node 400 may include a transceiver 401 and a controller 402.

The transceiver 401 may be configured to transmit first data and/or first control signaling to a second transceiving node, and/or receive second data and/or second control signaling from the second transceiving node.

The controller 402 may be an application specific integrated circuit or at least one processor. The controller 402 may be configured to control the overall operation of the first transceiving node 400, including controlling the transceiver 401 to transmit the first data and/or the first control signaling to the second transceiving node, and/or receive the second data and/or the second control signaling from the second transceiving node.

In some implementations, the controller 402 may be configured to perform one or more of operations in methods of various example embodiments described below, for example, operations that can be performed by a base station.

In the following description, the base station is taken as an example (but not limited thereto) to illustrate the first transceiving node, and the UE is taken as an example (but not limited thereto) to illustrate the second transceiving node. Downlink data (but not limited thereto) is used to illustrate the first data. Downlink control signaling (but not limited thereto) is used to illustrate the first control signaling. Uplink control signaling (but not limited thereto) is used to illustrate the second control signaling.

Herein, depending on the network type, the term “base station” or “BS” can refer to any component (or a set of components) configured to provide wireless access to a network, such as a Transmission Point (TP), a Transmission and Reception Point (TRP), an evolved base station (eNodeB or eNB), a 5G base station (gNB), a macrocell, a femtocell, a WiFi access point (AP), or other wireless network devices. Base stations may provide wireless access in accordance with one or more wireless communication protocols, e.g., 5G 3GPP new radio (NR) interface/access, Long Term Evolution (LTE), LTE advanced (LTE-A), High Speed Packet Access (HSPA), Wi-Fi 802.11a/b/g/n/ac, etc.

FIG. 5 illustrates a block diagram of a second transceiving node according to some embodiments of the disclosure.

Referring to FIG. 5, the second transceiving node 500 may include a transceiver 501 and a controller 502.

The transceiver 501 may be configured to receive first data and/or first control signaling from the first transceiving node, and transmit second data and/or second control signaling to the first transceiving node in a determined time unit.

The controller 502 may be an application specific integrated circuit or at least one processor. The controller 502 may be configured to control the overall operation of the second transceiving node and control the second transceiving node to implement the methods proposed in the example embodiments of the disclosure. For example, the controller 502 may be configured to determine the second data and/or the second control signaling and a time unit for transmitting the second data and/or the second control signaling based on the first data and/or the first control signaling, and control the transceiver 501 to transmit the second data and/or the second control signaling to the first transceiving node in the determined time unit.

In some implementations, the controller 502 may be configured to perform one or more of operations in methods of various example embodiments described below, for example, operations that can be performed by a terminal (e.g., UE).

In implementations described in connection with FIG. 4 or 5, the first data may be data transmitted by the first transceiving node to the second transceiving node. In the following examples, downlink data carried by a PDSCH (Physical Downlink Shared Channel) is taken as an example (but not limited thereto) to illustrate the first data.

In implementations described in connection with FIG. 4 or 5, the second data may be data transmitted by the second transceiving node to the first transceiving node. In the following examples, uplink data carried by a PUSCH (Physical Uplink Shared Channel) is taken as an example (but not limited thereto) to illustrate the second data.

In implementations described in connection with FIG. 4 or 5, the first control signaling may be control signaling transmitted by the first transceiving node to the second transceiving node. In the following examples, downlink control signaling is taken as an example (but not limited thereto) to illustrate the first control signaling. The downlink control signaling may be DCI (downlink control information) carried by a PDCCH (Physical Downlink Control Channel) and/or control signaling (e.g., higher signaling) carried by a PDSCH (Physical Downlink Shared Channel). For example, the DCI may be UE specific DCI, and the DCI may also be common DCI. The common DCI may be DCI common to a part of UEs, such as group common DCI, and the common DCI may also be DCI common to all of UEs in a serving cell (e.g., cell common DCI). The DCI may also be multicast DCI or broadcast DCI. The DCI may be uplink DCI (e.g., DCI for scheduling a PUSCH) and/or downlink DCI (e.g., DCI for scheduling a PDSCH).

It should be noted that in the description of the example embodiments of the disclosure, the following terms may be used interchangeably:
DCI
DCI format
PDCCH
grant
dynamic grant.

Referring to FIG. 4 or FIG. 5, the second control signaling may be control signaling transmitted by the second transceiving node to the first transceiving node. In the following examples, uplink control signaling is taken as an example (but is not limited thereto) to illustrate the second control signaling. The uplink control signaling may be UCI (Uplink Control Information) carried by a PUCCH (Physical Uplink Control Channel) and/or control signaling (e.g., higher signaling) carried by a PUSCH (Physical Uplink Shared Channel). A type of UCI may include one or more of: HARQ-ACK information, SR (Scheduling Request), LRR (Link Recovery Request), CSI (Chanel State Information), or CG (Configured Grant) UCI. In the example embodiments of the disclosure, when UCI is carried by a PUCCH, the UCI may be used interchangeably with the PUCCH.

According to an embodiment, a PUCCH with an SR may be a PUCCH with a positive SR and/or a negative SR. The SR may be the positive SR and/or the negative SR.

According to an embodiment, the CSI report may be Part 1 CSI and/or Part 2 CSI.

Referring to FIG. 4 or FIG. 5, a time unit in which the first transceiving node transmits the first data and/or the first control signaling may be a downlink time unit, such as a downlink slot.

Referring to FIG. 4 or FIG. 5, a time unit in which the second transceiving node transmits the second data and/or the second control signaling may be an uplink time unit, such as an uplink slot or PUCCH slot or PCell (Primary Cell) slot or PUCCH slot on PCell. The “PUCCH slot” may be understood as a PUCCH transmission slot.

In the example embodiments of the disclosure, a time unit (for example, a downlink time unit or an uplink time unit) may be one or more slots, one or more subslots, one or more OFDM symbols, one or more spans, one or more subframes, one or more frames or one or more half frames.

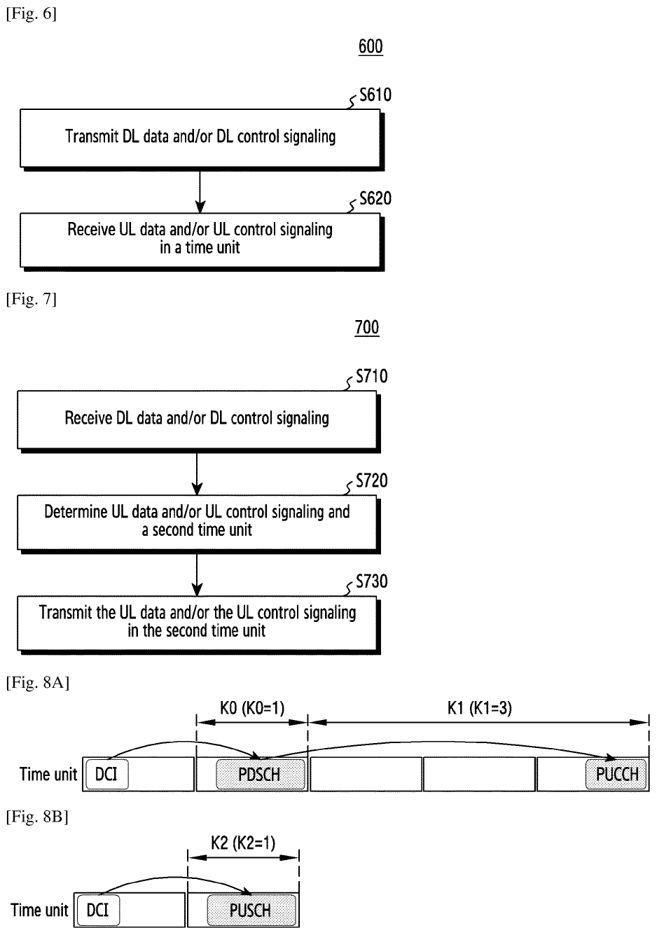

FIG. 6 illustrates a flowchart of a method 600 performed by a base station according to some embodiments of the disclosure.

Referring to FIG. 6, in operation S610, the base station transmits downlink data and/or downlink control signaling. For example, the base station transmits the downlink data and/or the downlink control signaling to the UE in a time unit.

In operation S620, the base station receives uplink data and/or uplink control signaling from the UE. For example, the base station receives the uplink data and/or the uplink control signaling from the UE in a time unit.

According to an embodiment, operations S610 and/or S620 may be performed based on the methods described according to various embodiments of the disclosure (e.g., various methods/manners described below).

According to an embodiment, the method 600 may omit one or more of operation S610 or S620, or may include additional operations, for example, the operations performed by the base station based on the methods described according to various embodiments of the disclosure (e.g., various methods/manners described below).

FIG. 7 illustrates a flowchart of a method 700 performed by a UE according to example embodiments of the disclosure.

Referring to FIG. 7, in operation S710, the UE may receive downlink (DL) data (e.g., downlink data carried by a PDSCH) and/or downlink control signaling from a base station. For example, the UE may receive the downlink data and/or the downlink control signaling from the base station based on predefined rules and/or received configuration parameters.

In operation S720, the UE determines uplink (UL) data and/or uplink control signaling, and/or a transmission power of the uplink data and/or the uplink control signaling, and/or a time unit based on the downlink data and/or the downlink control signaling.

In operation S730, the UE transmits the uplink data and/or the uplink control signaling to the base station. For example, the UE transmits the uplink data and/or the uplink control signaling to the base station in the determined time unit. For another example, the UE transmits the uplink data and/or the uplink control signaling to the base station in the determined time unit according to the determined transmission power.

### [HARQ/Scheduling General Timing]

In some implementations, operations S710 and/or S720 and/or S730 may be performed based on the methods described according to various example embodiments of the disclosure (e.g., various methods/manners described below).

In some implementations, the method 700 may omit one or more of operation S710, S720 or S730, or may include additional operations, for example, the operations performed by the UE (terminal) based on the methods described according to various example embodiments of the disclosure (e.g., various methods/manners described below).

According to an embodiment, acknowledgement/negative acknowledgement (ACK/NACK) for downlink transmission(s) may be performed through HARQ-ACK.

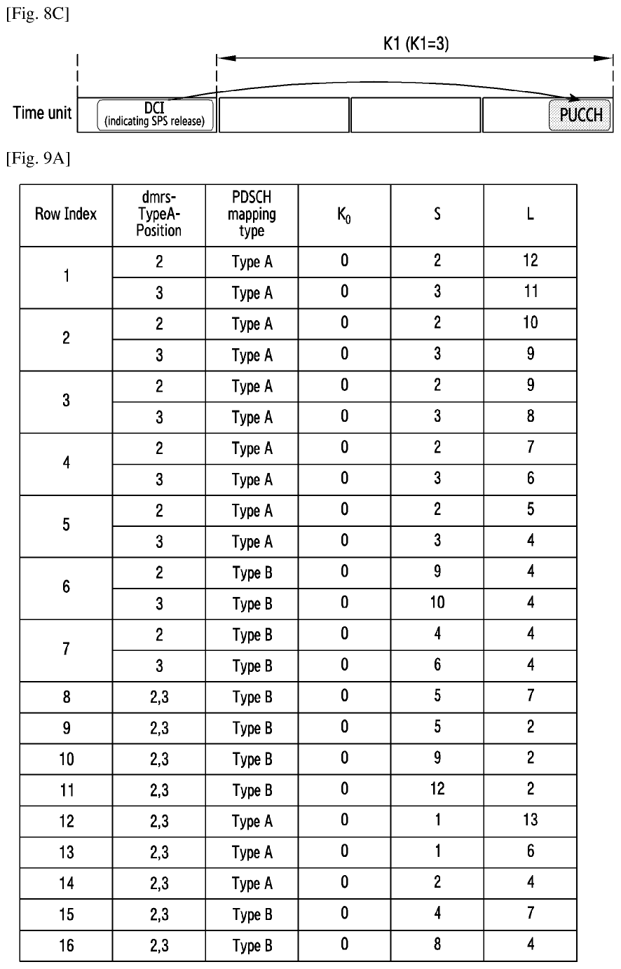

Some examples of uplink transmission timing will be described below with reference to FIGS. 8A-8C.

In an example, the UE receives a DCI format and receives a PDSCH based on time domain resources indicated by the DCI format. For example, a parameter K0 may be used to indicate a time interval between the PDSCH scheduled by the DCI format and a PDCCH carrying the DCI format, where K0 may be in units of slots. For example, FIG. 8A gives an example in which K0=1. In the example illustrated in FIG. 8A, the time interval from the PDSCH scheduled by the DCI format to the PDCCH carrying the DCI format is one slot. In the example embodiments of the disclosure, “the UE receives a DCI/DCI format” may refer to that “the UE detects the DCI/DCI format.”

In an example, the UE receives a DCI format and receives a PDSCH according to time domain resources indicated by the DCI format. For example, a parameter K0 may be used to indicate a time unit interval (offset) between the PDSCH scheduled by the DCI format and the DCI format (e.g., a PDCCH carrying the DCI format), where K0 may be in units of slots, for example, PDSCH slots (that is, slots of an active BWP in a serving cell where PDSCH is located). For example, FIG. 8A gives an example in which K0=1. In the example illustrated in FIG. 8A, the time unit interval from the PDSCH scheduled by the DCI format to the PDCCH carrying the DCI format is one slot. In the example embodiments of the disclosure, “the UE receives a DCI/DCI format” may refer to that “the UE detects the DCI/DCI format.”

In another example, the UE receives a DCI format and transmits a PUSCH based on time domain resources indicated by the DCI format. For example, a timing parameter K2 may be used to indicate a time unit interval between the PUSCH scheduled by the DCI format and the DCI format (e.g., a PDCCH carrying the DCI format), where K2 may be in units of slots, for example, PUSCH slots (that is, slots of an active BWP in a serving cell where PUSCH is located). For example, referring to FIG. 8B, an example in which K2=1 is illustrated. In the example illustrated in FIG. 8B, the time unit interval between the PUSCH scheduled by the DCI format and the PDCCH carrying the DCI is one slot. K2 may also be used to indicate a time unit interval between a PDCCH for activating CG (configured grant) PUSCH(s) and the first activated CG PUSCH (e.g., CG PUSCH transmission occasion). In examples of the disclosure, unless otherwise specified, the PUSCH may be a dynamically scheduled PUSCH (e.g., scheduled by DCI) (e.g., may be referred to as DG (dynamic grant) PUSCH, in the example embodiments of the disclosure) and/or a PUSCH not scheduled by DCI (e.g., CG PUSCH).

As another example, the UE receives a PDSCH, and may transmit HARQ-ACK information for the PDSCH reception in a PUCCH in a time unit (e.g., uplink time unit). For example, a timing parameter (which may also be referred to as a timing value) K1 (e.g., the higher layer parameter dl-DataToUL-ACK) may be used to indicate a time unit interval between the PUCCH with the HARQ-ACK information for the PDSCH reception and the PDSCH, and K1 may be in units of time units (e.g., uplink time units, such as PUCCH time units), such as slots or subslots. For example, FIG. 8A gives an example in which K1=3. In the example illustrated in FIG. 8A, the time unit interval between the PUCCH with the HARQ-ACK information for the PDSCH reception and the PDSCH is 3 slots. It should be noted that in the example embodiments of the disclosure, the timing parameter K1 may be used interchangeably with a time unit offset K1, the timing parameter K0 may be used interchangeably with a time unit offset K0, and the timing parameter K2 may be used interchangeably with a time unit offset K2.

The PDSCH may be a PDSCH scheduled by DCI and/or a SPS (semi-persistent scheduling) PDSCH. The UE periodically receives the SPS PDSCH after the SPS PDSCH is activated by the DCI. In examples of the disclosure, the SPS PDSCH may be equivalent to a PDSCH not scheduled by the DCI/PDCCH. After the SPS PDSCH is released (deactivated), the UE will no longer receive the SPS PDSCH.

In the example embodiments of the disclosure, HARQ-ACK may be HARQ-ACK for a SPS PDSCH reception (e.g., HARQ-ACK not indicated by DCI) and/or HARQ-ACK indicated by a DCI format (e.g., HARQ-ACK for a PDSCH reception scheduled by a DCI format). The PDSCH reception may be a PDSCH reception providing a transport block with enabled HARQ-ACK information. Or, for example, HARQ-ACK may be HARQ-ACK for a DCI format without scheduling PDSCH.

In yet another example, the UE receives DCI (e.g., DCI indicating SPS PDSCH release (deactivation)), and may transmit HARQ-ACK information for the DCI in a PUCCH in a time unit (e.g., uplink time unit). For example, the timing parameter K1 may be used to indicate a time unit interval between the PUCCH with the HARQ-ACK information for the DCI and the DCI, and K1 may be in units of time units (e.g., uplink time units), such as slots or subslots. For example, FIG. 8C gives an example in which K1=3. In the example of FIG. 8C, the time unit interval between the PUCCH with the HARQ-ACK information for the DCI and the DCI is 3 slots. For example, the timing parameter K1 may be used to indicate a time unit interval between a PDCCH reception carrying DCI indicating SPS PDSCH release (deactivation) and the PUCCH feeding back HARQ-ACK for the PDCCH reception.

According to an embodiment, in operation S720, the UE may report (or signal/transmit) a UE capability to the base station or indicate the UE capability. For example, the UE reports (or signals/transmits) the UE capability to the base station by transmitting the PUSCH. In this case, the UE capability information is included in the PUSCH transmitted by the UE.

According to an embodiment, the base station may configure higher layer signaling for the UE based on a UE capability received from the UE.

According to an embodiment, downlink channels (downlink resources) may include PDCCHs and/or PDSCHs. Uplink channels (uplink resources) may include PUCCHs and/or PUSCHs.

### [Two Levels of Priorities]

According to an embodiment, the UE may be configured with two levels of priorities for uplink transmission (for example, the UE is configured with the higher layer parameter PUCCH-ConfigurationList). The PUCCH resource configured by the first PUCCH-Config is a PUCCH resource of a lower priority, and the PUCCH resource configured by the second PUCCH-Config is a PUCCH resource of a higher priority. For another example, the priority of a PUCCH or a PUSCH may be indicated in a DCI format, for example, by a physical layer priority index (phy-PriorityIndex) field.

When two or more uplink physical channels on a serving cell overlap (for example, overlap in time), or PUCCH(s) and PUSCH(s) overlap (for example, overlap in time), it is necessary to resolve the overlapping for the physical channels. “Resolving the overlapping for the physical channels” may refer to “resolving the collision of overlapping physical channels”. The resulting physical channels after resolving the overlapping for the physical channels do not overlap or collide. The overlapping of physical channels may be resolved by multiplexing and/or prioritization. The multiplexing may refer to multiplexing UCI of two or more physical channels in a physical channel. For example, the multiplexing of multiple PUCCHs and/or PUSCHs that overlap in time domain may include multiplexing UCI of the PUCCHs in a PUCCH or PUSCH. It should be noted that in the description of the example embodiments of the disclosure, “resolving the overlapping for the physical channels” may also be used interchangeably with “determining the overlapping of the physical channels”. The prioritization may refer to transmitting a physical channel of the higher priority and not transmitting a physical channel of the lower priority. It should be noted that in the description of the example embodiments of this disclosure, “Not transmitting a physical channel”, “cancelling the transmission of a physical channel”, “stopping the transmission of a physical channel”, and “deprioritizing the priority of a physical channel” may be used interchangeably. For example, the prioritization of two PUCCHs and/or PUSCHs overlapping in time domain by the UE may include that the UE transmits the PUCCH or the PUSCH of the higher priority and/or the UE does not transmit the PUCCH or the PUSCH of the lower priority.

For example, in case that the UE is configured/indicated to multiplex UCIs (e.g., HARQ-ACK) of different priorities via higher layer signaling (e.g., via higher layer parameter uci-MuxWithDiffPrio), when resolving the overlapping for physical channels with different priorities, the UE may multiplex UCIs (e.g., HARQ-ACK) with different priorities; otherwise (e.g., in case that the UE is not configured the parameter for multiplexing UCIs with different priorities), when resolving the overlapping for physical channels with different priorities, the UE performs prioritization for PUCCHs and/or PUSCHs with different priorities.

For example, the two levels of priorities may include a first priority and a second priority which are different from each other. In an example, the first priority may be higher than the second priority, that is, the first priority is the higher priority, and the second priority is the lower priority. In another example, the first priority may be lower than the second priority. However, embodiments of the disclosure are not limited to this, and for example, the UE may be configured with more than two levels of priorities. For the sake of convenience, in some example embodiments of the disclosure, description will be made considering that the first priority is higher than the second priority. It should be noted that all embodiments of the disclosure are applicable to situations where the first priority may be higher than the second priority; all embodiments of the disclosure are applicable to situations where the first priority may be lower than the second priority; and all embodiments of the disclosure are applicable to situations where the first priority may be equal to the second priority. In some example embodiments of the disclosure, the terms “first priority”, “higher priority”, “greater priority index” and “priority index 1” may be used interchangeably. In the example embodiments of the disclosure, the terms “second priority”, “lower priority”, “smaller priority index” and “priority index 0” may be used interchangeably.

### [Subslot]

According to an embodiment, the UE may be configured with a subslot-based PUCCH transmission. For example, a subslot length parameter (which may also be referred to as a parameter with respect to a subslot length in the example embodiments of the disclosure) (e.g., the higher layer parameter subslotLengthForPUCCH) of each PUCCH configuration parameter of the first PUCCH configuration parameter and the second PUCCH configuration parameter may be 7 OFDM symbols or 6 OFDM symbols or 2 OFDM symbols. Subslot configuration length parameters in different PUCCH configuration parameters may be configured separately. In case that no subslot length parameter is configured in a PUCCH configuration parameter, the scheduling time unit of the PUCCH configuration parameter is one slot by default. In case that a subslot length parameter is configured in the PUCCH configuration parameter, the scheduling time unit of the PUCCH configuration parameter is L (L is the configured subslot configuration length) OFDM symbols.

The mechanism of a slot-based PUCCH transmission is basically the same as that of a subslot-based PUCCH transmission. In the disclosure, a slot may be used to represent a PUCCH occasion unit. For example, in case that the UE is configured with subslots, a slot which is a PUCCH occasion unit may be replaced with a subslot. For example, it may be specified by protocols that if the UE is configured with the subslot length parameter (e.g., the higher layer parameter subslotLengthForPUCCH), unless otherwise indicated, a number of symbols included in the slot of the PUCCH transmission is indicated by the subslot length parameter.

For example, in case that the UE is configured with the subslot length parameter, and a subslot n is the last uplink subslot overlapping with a PDSCH reception or PDCCH reception (e.g., SPS PDSCH release, and/or indicating SCell dormancy, and/or triggering a Type-3 HARQ-ACK codebook report and without scheduling PDSCH reception), then HARQ-ACK information for the PDSCH reception or PDCCH reception is transmitted in an uplink subslot n+k, where k is determined by the timing parameter K1 (the definition of the timing parameter K1 may refer to the previous description). For another example, in case that the UE is not configured with the subslot length parameter, and a slot n is the last uplink slot overlapping with a downlink slot where the PDSCH reception or PDCCH reception is located, then the HARQ-ACK information for the PDSCH reception or PDCCH reception is transmitted in an uplink slot n+k, where K is determined by the timing parameter K1.

### [Multicast Service (MBS)]

In the example embodiments of the disclosure, unicast may refer to a manner in which a network communicates with a UE, and multicast (or groupcast) may refer to a manner in which a network communicates with multiple UEs. For example, a unicast PDSCH may be a PDSCH received by one UE, and scrambling of the PDSCH may be based on a Radio Network Temporary Identifier (RNTI) specific to the UE, e.g., Cell-RNTI (C-RNTI). A multicast PDSCH may be a PDSCH received by more than one UE simultaneously, and scrambling of the multicast PDSCH may be based on a UE-group common RNTI. For example, the UE-group common RNTI for scrambling the multicast PDSCH may include an RNTI (which may be referred to as Group RNTI (G-RNTI) in the example embodiments of the disclosure) for scrambling of a dynamically scheduled multicast transmission (e.g., PDSCH) or an RNTI (which may be referred to as group configured scheduling RNTI (G-CS-RNTI) in the example embodiments of the disclosure) for scrambling of a multicast SPS transmission (e.g., SPS PDSCH). UCI of the unicast PDSCH may include HARQ-ACK information, an SR, or CSI of the unicast PDSCH reception. UCI of the multicast PDSCH may include HARQ-ACK information of the multicast PDSCH reception. In the example embodiments of the disclosure, “multicast” may also be replaced by “broadcast”

### [HARQ-ACK Codebook]

Referring to FIG. 7, in operation S710, the UE may receive downlink data (for example, downlink data carried by a PDSCH) and/or downlink control signaling (for example, a DCI format carried by a PDCCH) from the base station.

In operation S720, the UE determines HARQ-ACK information bit(s) transmitted in an uplink slot based on the downlink data and/or the downlink control signaling. The determination of the HARQ-ACK information bit(s) transmitted in the uplink slot includes at least one of the following:
determining the value(s) of the HARQ-ACK information bit(s);
determining the order of the HARQ-ACK information bit(s);
determining the total number of the HARQ-ACK information bit(s).

In operation S730, the UE transmits the HARQ-ACK information bit(s) to the base station. The UE may transmit the HARQ-ACK information bit(s) in a PUCCH or a PUSCH.

According to an embodiment, a HARQ-ACK codebook may include HARQ-ACK information (in the disclosure, it may also be called HARQ-ACK information bits) for one or more PDSCHs and/or DCI format(s) (e.g., DCI format without scheduling PDSCH). The HARQ-ACK information for the PDSCH reception may refer to HARQ-ACK information for a TB included in the PDSCH reception. In case that the UE is configured with PDSCH code block group (CBG) transmission (for example, the parameter PDSCH-CodeBlockGroupTransmission is configured), or in case that one PDSCH reception includes one or more CBGs, the HARQ-ACK information for the PDSCH reception may refer to HARQ-ACK information for the CBGs included in the PDSCH reception. If HARQ-ACK information for one or more PDSCH reception and/or DCI format(s) are indicated to be transmitted (or multiplexed) in a (e.g., same) time unit (e.g., uplink time unit) (e.g., in a PUCCH in a same time unit), the UE may generate the HARQ-ACK codebook based on a predefined rule. The generation of the HARQ-ACK codebook by the UE includes ordering the HARQ-ACK information bits and/or compressing (e.g., bundling) the HARQ-ACK information bits. For example, in case that a TB or CBG in a PDSCH reception is successfully decoded, HARQ-ACK information for the TB or CBG in the PDSCH reception is positive ACK. The positive ACK may be represented by 1 in the HARQ-ACK codebook. For example, in case that a TB or CBG in a PDSCH is not successfully decoded, HARQ-ACK information for the TB or CBG in the PDSCH reception is negative ACK (NACK). The NACK may be represented by 0 in the HARQ-ACK codebook. For example, the UE may generate the HARQ-ACK codebook based on pseudo codes specified by protocols. In an example, in case that the UE receives a DCI format that indicates SPS PDSCH release (deactivation), the UE transmits HARQ-ACK information (ACK) for the DCI format. In another example, in case that the UE receives a DCI format that indicates secondary cell dormancy, the UE transmits HARQ-ACK information (ACK) for the DCI format. In yet another example, in case that the UE receives a DCI format that indicates to transmit HARQ-ACK information (e.g., a Type-3 HARQ-ACK codebook) of all HARQ-ACK processes of all configured serving cells, the UE transmits the HARQ-ACK information of all the HARQ-ACK processes of all the configured serving cells. In order to reduce a size of the Type-3 HARQ-ACK codebook, in an enhanced Type-3 HARQ-ACK codebook, the UE may transmit HARQ-ACK information of a specific HARQ-ACK process of a specific serving cell based on an indication of the DCI. In yet another example, in case that the UE receives a DCI format that schedules a PDSCH reception, the UE transmits HARQ-ACK information for the PDSCH reception. In yet another example, the UE receives a SPS PDSCH, and the UE transmits HARQ-ACK information for the SPS PDSCH reception. In yet another example, in case that the UE is configured by higher layer signaling to receive a SPS PDSCH, the UE transmits HARQ-ACK information for the SPS PDSCH reception. The reception of the SPS PDSCH configured by higher layer signaling may be cancelled by other signaling. In yet another example, if at least one uplink symbol (e.g., OFDM symbol) of the UE in a semi-static frame structure configured by higher layer signaling overlaps with a symbol of the SPS PDSCH reception, the UE does not receive the SPS PDSCH. In yet another example, if the UE is configured by higher layer signaling to receive a SPS PDSCH according to a predefined rule, the UE transmits HARQ-ACK information for the SPS PDSCH reception. It should be noted that, in the example embodiments of the disclosure, “‘A’ overlaps with ‘B’” may mean that ‘A’ at least partially overlaps with ‘B’. That is, “‘A’ overlaps with ‘B’” includes a case where ‘A’ completely overlaps with ‘B’. “‘A’ overlaps with ‘B’” may mean that ‘A’ overlaps with ‘B’ in time domain and/or ‘A’ overlaps with ‘B’ in frequency domain.

According to an embodiment, in case that HARQ-ACK information transmitted (or multiplexed) in a same time unit (e.g., uplink time unit) does not include HARQ-ACK information for any DCI format, nor does it include HARQ-ACK information for a dynamically scheduled PDSCH reception (e.g., a PDSCH reception scheduled by a DCI format) and/or DCI, or the HARQ-ACK information transmitted (or multiplexed) in the same time unit (e.g., uplink time unit) only includes HARQ-ACK information for one or more SPS PDSCH receptions, the UE may generate HARQ-ACK information (e.g., HARQ-ACK information only for SPS PDSCH receptions) according to a rule for generating a HARQ-ACK codebook for SPS PDSCH receptions. The UE may multiplex the HARQ-ACK information only for SPS PDSCH receptions in a specific PUCCH resource. For example, in case that the UE is configured with a PUCCH list parameter for SPS (e.g., SPS-PUCCH-AN-List), the UE multiplexes the HARQ-ACK information only for SPS PDSCH receptions in a PUCCH of a PUCCH list for SPS. For example, the UE determines a PUCCH resource in the PUCCH list for the SPS according to a number of HARQ-ACK information bits. In case that the UE is not configured with the PUCCH list parameter for SPS, the UE multiplexes the HARQ-ACK information only for SPS PDSCH receptions in a PUCCH resource specific to SPS HARQ-ACK (for example, the PUCCH resource is configured by the parameter nlPUCCH-AN).

According to an embodiment, if HARQ-ACK information transmitted (or multiplexed) in a same time unit (e.g., uplink time unit) includes HARQ-ACK information for a DCI format, and/or a dynamically scheduled PDSCH reception (e.g., a PDSCH reception scheduled by a DCI format), the UE may generate HARQ-ACK information according to a rule for generating a HARQ-ACK codebook for a dynamically scheduled PDSCH reception and/or a DCI format. The UE may determine to generate a semi-static HARQ-ACK codebook (e.g., Type-1 HARQ-ACK codebook) or a dynamic HARQ-ACK codebook (e.g., Type-2 HARQ-ACK codebook) according to a PDSCH HARQ-ACK codebook configuration parameter (e.g., the higher layer parameter pdsch-HARQ-ACK-Codebook). For example, if the UE is configured with a HARQ-ACK codebook configuration parameter (e.g., the higher layer parameter pdsch-HARQ-ACK-Codebook) as “semi-static”, the UE generates a semi-static HARQ-ACK codebook. If the UE is configured with a HARQ-ACK codebook configuration parameter (e.g., the higher layer parameter pdsch-HARQ-ACK-Codebook) as “dynamic”, the UE generates a dynamic HARQ-ACK codebook. The dynamic HARQ-ACK codebook may also be an enhanced dynamic HARQ-ACK codebook (e.g., Type-2 HARQ-ACK codebook based on grouping and HARQ-ACK retransmission). The UE may multiplex the HARQ-ACK information in a PUCCH resource for HARQ-ACK associated with dynamically scheduling, which may be configured in a resource set list parameter (e.g., parameter resourceSetToAddModList). The UE determines a PUCCH resource set (e.g., parameter PUCCH-ResourceSet) in a resource set list according to a number of HARQ-ACK information bits, and the PUCCH resource may be determined as a PUCCH in the PUCCH resource set according to a PRI (PUCCH Resource Indicator) field indication in the last DCI format.

According to an embodiment, in case that HARQ-ACK information transmitted (multiplexed) in a same time unit (e.g., uplink time unit) includes only HARQ-ACK information for SPS PDSCHs (e.g., PDSCH receptions not scheduled by DCI formats), the UE may generate the HARQ-ACK codebook according to a rule for generating a HARQ-ACK codebook for SPS PDSCH receptions (e.g., the pseudo code for a HARQ-ACK codebook for SPS PDSCH receptions).

### [Type-1 HARQ-ACK Codebook]

The semi-static HARQ-ACK codebook (e.g., Type-1 HARQ-ACK codebook), may determine the size of the HARQ-ACK codebook and an order of HARQ-ACK information bits according to a semi-statically configured parameter (e.g., a parameter configured by higher layer signaling).

For a serving cell c, an active downlink BWP (bandwidth part), and an active uplink BWP, the UE determines a set of M_{A,c} occasions for candidate PDSCH receptions for which the UE can transmit corresponding HARQ-ACK information in a PUCCH in an uplink slot n_{U}.

M_{A,c} may be determined by at least one of:
a) a set of HARQ-ACK slot timing values K1 associated with the active uplink BWP on a primary cell or PUCCH-sScell (PUCCH switching SCell);
b) a set of row indexes of a time domain resource allocation (TDRA) table associated with the active downlink BWP;
c) 2^{μ}^{_{DL}}^{-μ}^{_{UL}}, where μ_{DL} is the configuration of a downlink subcarrier spacing (SCS) of the downlink active BWP, and μ_{UL} is the configuration of an uplink subcarrier spacing of the active uplink BWP.
d) a semi-static uplink and downlink frame structure configuration, such as the parameter tdd-UL-DL-ConfigurationCommon and the parameter tdd-UL-DL-ConfigurationDedicated.
e) a downlink slot offset parameter (e.g., the higher layer parameter N_{slot,offset,c}^{DL}) for the serving cell c and its corresponding slot offset SCS (e.g., the higher layer parameter μ_{offset,DL,c}), and a slot offset parameter (e.g., the higher layer parameter N_{slot,offset}^{UL}) for a primary cell and its corresponding slot offset SCS (e.g., the higher layer parameter μ_{offset,UL}).

According to an embodiment, the set of the parameter K1 is used to determine a candidate uplink slot, and then determine candidate downlink slots according to the candidate uplink slot. The candidate downlink slots satisfy at least one of the following conditions: (i) in case that the time unit of the PUCCH is a subslot, the end of at least one candidate PDSCH reception in the candidate downlink slots overlaps with the candidate uplink slot in time domain; or (ii) in case that the time unit of the PUCCH is a slot, the end of the candidate downlink slots overlaps with the candidate uplink slot in time domain. It should be noted that, in the description of the example embodiments of the disclosure, a starting symbol may be used interchangeably with a starting position, and an end symbol may be used interchangeably with an end position. In some implementations, the starting symbol may be replaced by the end symbol, and/or the end symbol may be replaced by the starting symbol.

A number of PDSCH receptions in a candidate downlink slot for which HARQ-ACK needs to be fed back is determined by a maximum value of a number of non-overlapping valid candidate PDSCH receptions in the downlink slot (e.g., the valid candidate PDSCH receptions may be candidate PDSCH receptions that do not overlap with semi-statically configured uplink symbols). Time domain resources occupied by the candidate PDSCH receptions may be determined by (i) a time domain resource allocation table configured by higher layer signaling (in the example embodiments of the disclosure, it may also be referred to as a table associated with time domain resource allocation) and (ii) a certain row in the time domain resource allocation table dynamically indicated by a DCI. Each row in the time domain resource allocation table may define information with respect to time domain resource allocation. For example, for the time domain resource allocation table, an indexed row defines a timing value (e.g., time unit (e.g., slot) offset (e.g., K0)) between a PDCCH and a PDSCH, and a start and length indicator (SLIV), or directly defines a starting symbol and allocation length. For example, for the first row of the time domain resource allocation table, a starting OFDM symbol is 0 and an OFDM symbol length is 4; for the second row of the time domain resource allocation table, the starting OFDM symbol is 4 and the OFDM symbol length is 4; and for the third row of the time domain resource allocation table, the starting OFDM symbol is 7 and the OFDM symbol length is 4. The DCI for scheduling the PDSCH may indicate any row in the time domain resource allocation table. When all OFDM symbols in the downlink slot are downlink symbols, the maximum value of the number of non-overlapping valid PDSCHs in the downlink slot is 2. At this time, the Type-1 HARQ-ACK codebook may need to feed back HARQ-ACK information for two PDSCHs in the downlink slot on the serving cell.

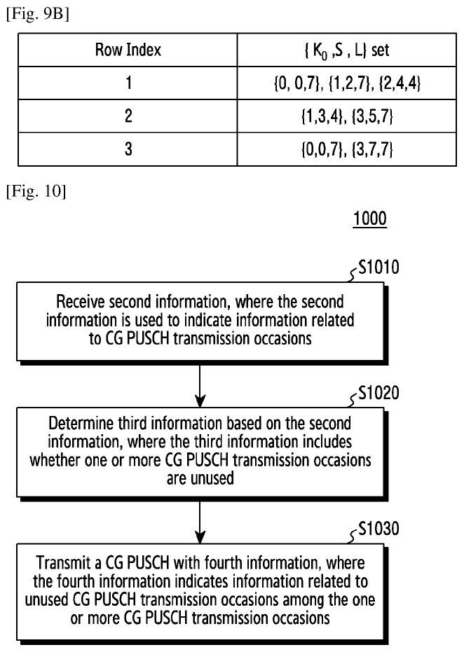

FIGS. 9A and 9B illustrate examples of time domain resource allocation tables (TDRAs). For example, FIG. 9A illustrates a time domain resource allocation table in which one PDSCH is scheduled in one row, and FIG. 9B illustrates a time domain resource allocation table in which multiple PDSCHs are scheduled in one row. Referring to FIG. 9A, each row corresponds to a set of {K0, mapping type, SLIV}, which includes a timing parameter K0 value, a mapping type, and an SLIV. Referring to FIG. 9B, unlike FIG. 9A, each row corresponds to multiple sets of {K0, mapping type, SLIV}.

### [Type-2 HARQ-ACK Codebook]

In some implementations, the dynamic HARQ-ACK codebook (e.g., Type-2 HARQ-ACK codebook) and/or the enhanced dynamic HARQ-ACK codebook (e.g., Type-2 HARQ-ACK based on grouping and HARQ-ACK retransmission) may determine a size and an order of the HARQ-ACK codebook according to an assignment indicator. For example, the assignment indicator may be a DAI (Downlink Assignment Indicator). In the following embodiments, the assignment indicator as the DAI is taken as an example for illustration. However, the example embodiments of the disclosure are not limited thereto, and any other suitable assignment indicator may be adopted.

It should be noted that the method for dynamic HARQ-ACK codebook in the disclosure may also be used for enhanced dynamic HARQ-ACK codebook.

According to an embodiment, the DAI includes at least one of a first DAI and a second DAI.

In some examples, the first DAI may be a C-DAI (Counter-DAI). The first DAI may be the accumulative number of the downlink assignment indexes. The value of the first DAI field in a DCI format is the accumulative number of {serving cell, monitoring occasion (MO)}-pair(s) up to the current serving cell and the current time unit, where the time unit may be the time unit of the PDCCH reception, such as the PDCCH monitoring occasion. The {serving cell, PDCCH monitoring occasion}-pair(s) may include a DCI format scheduling PDSCH reception, and/or a DCI format having associated HARQ-ACK information without scheduling PDSCH reception. The first DAI may be included in a downlink DCI format. The HARQ-ACK information for the PDSCH reception scheduled by the DCI format and/or the DCI format without scheduling PDSCH reception is transmitted in a same time unit (for example, transmitted in a same PUCCH in the same time unit). The second DAI may be a T-DAI (Total-DAI). The second DAI may be the total number of the downlink assignment indexes. The value of the second DAI field in a DCI format is the total number of {serving cell, PDCCH monitoring occasion}-pair(s) up to the current time unit. The second DAI may be included in a downlink DCI format and/or an uplink DCI format. The second DAI included in the uplink DCI format is also called UL DAI.

In some embodiments, the first DAI may be ordered in the following order:
first in ascending order of serving cell (e.g., scheduled serving cell) index;
second in ascending order of PDCCH MO index.

In some embodiments, the first DAI may also be ordered in the following order. For example, if the UE reports a capability to support more than one PDSCH reception on a serving cell scheduled from a PDCCH MO (for example, the PDSCH reception scheduled by more than one PDCCH), the first DAI may be ordered in the following order:
first in increasing order of the PDSCH reception starting time (for example, first in increasing order of the PDSCH reception starting time for the same {serving cell, PDCCH monitoring occasion}-pair);
second in ascending order of serving cell (e.g., scheduled serving cell) index;
third in ascending order of PDCCH MO index.

In some examples, the first DAI may indicate an accumulative number of at least one of DCI scheduling PDSCH reception(s), DCI format(s) indicating SPS PDSCH release (deactivation), or DCI format(s) indicating secondary cell dormancy. For example, the accumulative number may be an accumulative number up to the current serving cell and/or the current time unit. The C-DAI may also indicate: an accumulative number of {serving cell, time unit} pair(s) scheduled by PDCCH(s) up to the current time unit within a time window (which may also include a number of PDCCHs (e.g., PDCCHs indicating SPS release and/or PDCCHs indicating secondary cell dormancy)); or an accumulative number of PDCCH(s) up to the current time unit; or an accumulative number of PDSCH transmission(s) up to the current time unit; or an accumulative number of {serving cell, time unit} pair(s) in which PDSCH transmission(s) related to PDCCH(s) (e.g., scheduled by the PDCCH(s)) and/or PDCCH(s) (e.g., PDCCH indicating SPS release and/or PDCCH indicating secondary cell dormancy) is present, up to the current serving cell and/or the current time unit; or an accumulative number of PDSCH(s) with corresponding PDCCH(s) and/or PDCCHs (e.g., PDCCHs indicating SPS release and/or PDCCHs indicating secondary cell dormancy) already scheduled by a base station up to the current serving cell and/or the current time unit; or an accumulative number of PDSCHs (the PDSCHs are PDSCHs with corresponding PDCCHs) already scheduled by the base station up to the current serving cell and/or the current time unit; or an accumulative number of time units with PDSCH transmissions (the PDSCHs are PDSCHs with corresponding PDCCHs) already scheduled by the base station up to the current serving cell and/or the current time unit. The order of each bit in the HARQ-ACK codebook corresponding to at least one of PDSCH reception(s), DCI format(s) indicating SPS PDSCH release (deactivation), or DCI format(s) indicating secondary cell dormancy may be determined by the time when the first DAI is received and the information of the first DAI.

In some examples, the second DAI may indicate a total number of at least one of all PDSCH receptions, DCI format(s) indicating SPS PDSCH release (deactivation), or DCI format(s) indicating secondary cell dormancy. For example, the total number may be a total number of all serving cells up to the current time unit. For example, the T-DAI may refer to: a total number of {serving cell, time unit} pairs scheduled by PDCCH(s) up to the current time unit within a time window (which may also include a number of PDCCHs for indicating SPS release); or a total number of PDSCH transmissions up to the current time unit; or a total number of {serving cell, time unit} pairs in which PDSCH transmission(s) related to PDCCH(s) (e.g., scheduled by the PDCCH) and/or PDCCH(s) (e.g., a PDCCH indicating SPS release and/or a PDCCH indicating secondary cell dormancy) is present, up to the current serving cell and/or the current time unit; or a total number of PDSCHs with corresponding PDCCHs and/or PDCCHs (e.g., PDCCHs indicating SPS release and/or PDCCHs indicating secondary cell dormancy) already scheduled by a base station up to the current serving cell and/or the current time unit; or a total number of PDSCHs (the PDSCHs are PDSCHs with corresponding PDCCHs) already scheduled by the base station up to the current serving cell and/or the current time unit; or a total number of time units with PDSCH transmissions (e.g., the PDSCHs are PDSCHs with corresponding PDCCHs) already scheduled by the base station up to the current serving cell and/or the current time unit.

In the following examples, the first DAI as the C-DAI and the second DAI as the T-DAI are taken as an example (but not limited thereto) for illustration.

Tables 1 and 2 show a correspondence between the DAI field and V_{T-DAI,m} or V_{C-DAI,c,m} or V_{T-DAI}^{UL}. Numbers of bits of the C-DAI and T-DAI are limited.

For example, in case that a C-DAI or T-DAI in a DCI format is represented with 2 bits, the value of the C-DAI or T-DAI in the DCI format may be determined by equations in Table 1. V_{T-DAI,m} ON V_{T-DAI}^{UL} is the value of the T-DAI in the DCI format received in a PDCCH Monitoring Occasion (MO) m, and V_{C-DAI,c,m} is the value of the C-DAI in the DCI format for a serving cell c received in the PDCCH monitoring occasion m. Both V_{T-DAI,m} and V_{C-DAI,c,m} are related to a number of bits of the DAI field in the DCI format. MSB is the Most Significant Bit and LSB is the Least Significant Bit.

TABLE 1

| MSB, LSB | V_{T-DAI,m} or | |
|---|---|---|
| of DAI | V_{C-DAI,c,m} | |
| Field | or V^{UL}_{T-DAI} | Y |
| 0, 0 | 1 | (Y-1) mod4 + 1 = 1 |
| 0, 1 | 2 | (Y-1) mod4 + 1 = 2 |
| 1, 0 | 3 | (Y-1) mod4 + 1 = 3 |
| 1, 1 | 4 | (Y-1) mod4 + 1 = 4 |

For example, when the C-DAI or T-DAI is 1, 5 or 9, as shown in Table 1, all of the DAI field are indicated with “00”, and the value of V_{T-DAI,m} or V_{C-DAI,c,m} is represented as “1” by the equation in Table 1. Y may represent the value of the DAI corresponding to the number of DCIs actually transmitted by the base station (the value of the DAI before conversion by the equation in the table).

For example, in case that the C-DAI or T-DAI in the DCI format is 1 bit, values greater than 2 may be represented by equations in Table 2.

TABLE 2

| DAI Field | V_{T-DAI,m} or V_{C-DAI,c,m} | Y |
|---|---|---|
| 0 | 1 | (Y-1) mod2 + 1 = 1 |
| 1 | 2 | (Y-1) mod2 + 1 = 2 |

In some embodiments, the UE may generate a HARQ-ACK codebook in a PUCCH according to pseudo-code 1. For example, if the UE transmits HARQ-ACK information in a PUCCH in time slot n (for example, and for any PUCCH format), the UE determines the

$${\tilde{o}}_{0}^{ACK} , {\tilde{o}}_{1}^{ACK} , … , {\tilde{o}}_{{O}_{ACK} - 1}^{ACK}$$

HARQ-ACK information bits according to pseudo-code 1, where O_{ACK} is the total number of HARQ-ACK information bits.

### [Pseudo-Code 1] is Illustrated in [Table 3]

TABLE 3
$Denote {N}_{C - DAI}^{DL} the number of bits for the C - DAI and set {T}_{D} = {2}^{{N}_{C - DAI}^{DL}} .$
$Denote {V}_{C - DAI , c , m}^{DL} the value of the C - DAI in a DCI format on serving cell c in$
PDCCH monitoring occasion m.
$Denote {V}_{T - DAI , m}^{DL} the value of the T - DAI in a DCI format in PDCCH monitoring$
occasion m.
Set m = 0 - PDCCH monitoring occasion index: lower index corresponds to
earlier PDCCH monitoring occasion
Set j = 0
Set Vₜₑₘₚ = 0
Set Vₜₑₘₚ₂ = 0
Set Vₛ = Ø
$Set {N}_{cells}^{D L} to the number of serving cells configured by higher layers for the UE$
Set M to the number of PDCCH monitoring occasion(s)
while m < M
Set c = 0 - serving cell index: lower indexes correspond to lower RRC indexes of
corresponding cell
$while c < {N}_{cells}^{D L}$
if PDCCH monitoring occasion m is before an active DL BWP change on serving
cell c or an active UL BWP change on the PCell, and/or a DL BWP change is not
triggered in PDCCH monitoring occasion m
c = c + 1;
else
if there is a DCI format indicating associated HARQ-ACK information on serving
cell c in PDCCH monitoring occasion m
$if {V}_{C - DAI , c , m}^{D L} \leq {V}_{temp}$
j = j + 1
end if
${V}_{temp} = {V}_{C - DAI , c , m}^{DL}$
$if {V}_{T - DAI , m}^{D L} = ∅$
${V}_{temp 2} = {V}_{C - DAI , c , m}^{DL}$
else
${V}_{tem} = {V}_{T - DAI , m}^{DL}$
end if
if UE is not configured with a parameter related to HARQ-ACK spatial bundling of
PUCCH (e.g., parameter harq-ACK-SpatialBundlingPUCCH) and the UE is
configured with reception of two transport blocks for at least one DL BWP of at
least one serving cell (e.g., by the 3GPP parameter
maxNrofCodeWordsScheduledByDCI),
${\tilde{o}}_{2 \cdot {T}_{D} \cdot j + 2 ( {V}_{C - DAI , c , m}^{DL} - 1 )}^{A C K} = HARQ - ACK nformation bit corresponding to the first$
transport block of this cell
${\tilde{o}}_{2 \cdot {T}_{D} \cdot j + 2 ( {V}_{C - DAI , c , m}^{D L} - 1 ) + 1}^{A C K} = HARQ - ACK information bit corresponding to the$
second transport block of this cell
${V}_{s} = {V}_{s} ⋃ \{ 2 \cdot {T}_{D} \cdot j + 2 ( {V}_{C - DAI , c , m}^{DL} - 1 ) , 2 \cdot {T}_{D} \cdot j + 2 ( {V}_{C - D A I , c , m}^{D L} - 1 ) + 1 \}$
elseif UE is configured with the parameter related to HARQ-ACK spatial bundling
of PUCCH (e.g., parameter harq-ACK-SpatialBundlingPUCCH) and the UE is
configured with reception of two transport blocks for at least one DL BWP of at
least one serving cell (e.g., by the 3GPP parameter
maxNrofCodeWordsScheduledByDCI), and m is a monitoring occasion in which a
DCI format scheduling two transport blocks can be received,
${\tilde{o}}_{{T}_{D} \cdot j + {V}_{C - DA , c , m}^{D L} - 1}^{A C K} = binary AND operation of the HARQ - ACK information bits$
corresponding to the first and second transport blocks of serving cell c
${V}_{s} = {V}_{s} ⋃ \{ {T}_{D} \cdot j + {V}_{C - DAI , c , m}^{DL} - 1 \}$
else
${\tilde{o}}_{{T}_{D} \cdot j + {V}_{C - DAI , c , m}^{D L} - 1}^{ACK} = HARQ - ACK information bit of this cell$
${V}_{s} = {V}_{s} ⋃ \{ {T}_{D} \cdot j + {V}_{C - DAI , c , m}^{DL} - 1 \}$
end if
end if
c = c + 1
end if
end while
m = m + 1
end while
${V}_{temp} = ( j mod ( \frac{4}{{T}_{D}} ) ) \times ( \frac{4}{{T}_{D}} ) + {V}_{temp}$
$if UE does not set {V}_{temp} = {V}_{T - DAI}^{UL} and {T}_{D} = 2$
Vₜₑₘₚ₂ = Vₜₑₘₚ
end if
$j = ⌊ \frac{j \times {T}_{D}}{4} ⌋$
if Vₜₑₘₚ₂ < Vₜₑₘₚ
j = j + 1
end if
if UE is not configured with the parameter related to HARQ-ACK spatial bundling
of PUCCH (e.g., parameter harq-ACK-SpatialBundlingPUCCH) and the UE is
configured with reception of two transport blocks for at least one DL BWP of at
least one serving cell (e.g., by the 3GPP parameter
maxNrofCodeWordsScheduledByDCI),
O^{ACK} = 2 · (4 · j + Vₜₑ)
else
O^{ACK} = 4 · j + Vₜₑₘₚ₂
end if
${\tilde{o}}_{i}^{ACK} = NACK , for any i ∈ \{ 0 , 1 , … , {O}^{ACK} - 1 \} \backslash {V}_{s}$

According to an embodiment, for a HARQ-ACK codebook in a PUSCH, the UE may set

$${V}_{t emp 2} = {V}_{T - DAI}^{UL}$$

after completing the c and m loops of generating the HARQ-ACK codebook in pseudo-code 1, where

$${V}_{T - DAI}^{UL}$$

is UL DAI, the value of which may be determined according to Table 1 or Table 2.

### [HARQ-ACK Feed Mode]

According to an embodiment, whether to feed back HARQ-ACK information may be configured by higher layer parameters or dynamically indicated by a DCI. The mode of feeding back (or reporting) the HARQ-ACK information (HARQ-ACK feedback mode or HARQ-ACK reporting mode) may also be at least one of the following modes.
HARQ-ACK feedback mode 1: transmitting ACK or NACK (ACK/NACK). For example, for a PDSCH reception, if the UE decodes a corresponding transport block (TB) correctly, the UE transmits ACK; and/or, if the UE does not decode the corresponding transport block correctly, the UE transmits NACK. For example, a HARQ-ACK information bit of the HARQ-ACK information provided according to the HARQ-ACK feedback mode 1 is an ACK value or a NACK value.
HARQ-ACK feedback mode 2: transmitting NACK only (NACK-only). For example, for a PDSCH reception, if the UE decodes the corresponding transport block correctly, the UE does not transmit the HARQ-ACK information; and/or, if the UE does not decode the corresponding transport block correctly, the UE transmits NACK. For example, at least one HARQ-ACK information bit of the HARQ-ACK information provided according to the HARQ-ACK feedback mode 2 is a NACK value. For example, for the HARQ-ACK feedback mode 2, the UE does not transmit a PUCCH that would include only HARQ-ACK information with ACK values.

For a PDSCH reception of a HARQ process, if the UE is configured not to feed back HARQ-ACK information, the HARQ-ACK codebook does not include HARQ-ACK information for the PDSCH reception.

### [Channel Collision]

According to an embodiment, a PUSCH conflicting/colliding with other physical channel(s) may be at least one of:
a PUSCH overlapping in time domain with other PUSCH(s) and/or PUCCH(s) and/or PDSCH(s) and/or PDCCH(s) on a same serving cell;
in case that simultaneous transmission for PUSCH is not configured, a PUSCH overlapping in time domain with other PUSCH(s) on a same serving cell;
in case that the simultaneous transmission for PUSCH is configured, a PUSCH overlapping in time domain with another PUSCH, on a same serving cell, with a same value of a CORESET pool index parameter (e.g., coresetPoolIndex); or
a PUSCH overlapping in time domain with a PUCCH. For example, a PUSCH overlaps in time domain with a PUCCH on a different serving cell, and/or the serving cell does not support simultaneous transmission of the PUSCH and the PUCCH.

In some implementations, a PDSCH conflicting/colliding with other physical channel(s) may be at least one of:
a PDSCH overlapping in time domain with other PUSCH(s) and/or PUCCH(s) and/or PDSCH(s) on a same serving cell;
in case that simultaneous reception for PDSCH is not configured (for example, the UE is not configured with different values of the CORESET pool index parameter (e.g., coresetPoolIndex)), a PDSCH overlapping in time domain with other PUSCH(s) on a same serving cell;
in case that simultaneous transmission for PDSCH is configured (for example, the UE is configured with a PDCCH configuration parameter (e.g., PDCCH-Config) including a CORESET parameter (e.g., ControlResourceSet) with different values of the CORESET pool index parameter (e.g., coresetPoolIndex)), a PDSCH overlapping in time domain with another PDSCH on a same serving cell with a same value of the CORESET pool index parameter (e.g., coresetPoolIndex); or
a PDSCH overlapping in both time domain and frequency domain with a PDCCH on a same serving cell.

In some implementations, a PUCCH conflicting/colliding with other physical channel(s) may be at least one of:
a PUCCH overlapping in time domain with other PUCCH(s) and/or PUSCH(s); or
a PUCCH overlapping in time domain with other PDSCH(s) on a same serving cell.

In some implementations, a PDCCH conflicting/colliding with other physical channel(s) may be at least one of:
a PDCCH overlapping in time domain with other PUSCH(s) and/or PUCCH(s) on a same serving cell; or
a PDCCH overlapping in both time domain and frequency domain with other PDSCH(s) on a same serving cell.

According to an embodiment, “a set of overlapping channels” may be understood as that each channel of the set of overlapping channels overlaps (or collides) with at least one of channels in the set except this channel. The channels may include one or more PUCCHs and/or one or more PUSCHs. For example, “a set of overlapping channels” may include “a set of overlapping PUCCHs and/or PUSCHs”. As a specific example, when a first PUCCH overlaps with at least one of a second PUCCH and a third PUCCH, the second PUCCH overlaps with at least one of the first PUCCH and the third PUCCH, and the third PUCCH overlaps with at least one of the first PUCCH and the second PUCCH, the first PUCCH, the second PUCCH and the third PUCCH constitute a set of overlapping channels (PUCCHs). For example, the first PUCCH overlaps with the second PUCCH and the third PUCCH, and the second PUCCH and the third PUCCH do not overlap.

It should be noted that, in the description of the example embodiments of the disclosure, “resolving overlapping channels” may be understood as resolving the collision of overlapping channels. For example, when a PUCCH overlaps with a PUSCH, resolving the overlapping or collision may include multiplexing UCI of the PUCCH in the PUSCH, or may include transmitting the PUCCH or PUSCH with a higher priority. For another example, when a PUCCH overlaps with one or another PUCCH, resolving the overlapping or collision may include multiplexing UCI in a PUCCH, or may include transmitting the PUCCH with a higher priority. For example, when two PUSCHs on a same serving cell overlap, resolving the overlapping or collision may include transmitting a PUSCH with a higher priority of the two PUSCHs. “Resolving overlapping channels”, “resolving the overlapping for channels”, “determining overlapping channels”, and “determining the overlapping for channels” may be used interchangeably.

In case that the UE would transmit multiple overlapping PUCCHs in a slot or multiple overlapping PUCCHs and PUSCHs in a slot, and the UE is configured to multiplex different UCI types in one PUCCH, and at least one of the multiple overlapping PUCCHs or the PUSCHs is in response to a DCI format detection by the UE, if the following conditions (in the example embodiments of the disclosure, such conditions may be called conditions for UCI multiplexing, or simply UCI multiplexing conditions) are satisfied, the UE multiplexes all corresponding UCI types. If one of the PUCCH transmissions or PUSCH transmissions is in response to a DCI format detection by the UE, the UE expects that the first symbol S₀ of the earliest PUCCH or PUSCH, among a group of overlapping PUCCHs and PUSCHs in a slot, satisfies the following timeline conditions (in the example embodiments of the disclosure, such timeline conditions may be called conditions for UCI multiplexing, or simply UCI multiplexing conditions)
If there is no aperiodic CSI report multiplexed in a PUSCH in the group of overlapping PUCCHs and PUSCHs (or if at least one PUSCH is included in the group of overlapping PUCCHs and PUSCHs), S₀ is not before a symbol (with CP) starting after

$${T}_{proc , 2}^{mux}$$

time after the last symbol of
any PDCCH with a DCI format scheduling an overlapping PUSCH, and
any PDCCH providing a DCI format indicating/with corresponding HARQ-ACK information in an overlapping PUCCH in the slot.
If there is at least one PUSCH in the group of overlapping PUCCHs and PUSCHs,

$${T}_{p r oc , 2}^{m u x}$$

is given by maximum of

$$\{ {T}_{proc , 2}^{mux , 1} , … , {T}_{proc , 2}^{mux , i} , … \} ,$$

where for the i-th PUSCH which is in the group of overlapping PUCCHs and PUSCHs,

$${T}_{proc , 2}^{mux , i} = max ( ( {N}_{2} + {d}_{2 , 1} + 1 ) \cdot ( 2048 + 144 ) \cdot κ \cdot {2}^{- μ} \cdot {T}_{C} + {T}_{switch} , {d}_{2 , 2} ) , or$$

$${T}_{proc , 2}^{mux , i} = max ( ( {N}_{2} + {d}_{2 , 1} + 1 ) \cdot ( 2048 + 144 ) \cdot κ \cdot {2}^{- μ} \cdot {T}_{C} + {T}_{switch} , {d}_{2 , 2} ) , or$$

$${T}_{proc , 2}^{mux , i} = max ( ( {N}_{2} + {d}_{2 , 1} + 1 ) \cdot ( 2048 + 144 ) \cdot κ \cdot {2}^{- μ} \cdot {T}_{C +} {T}_{switch} , {d}_{2 , 2} ) ,$$

where d_{2,1}, d_{2,2} and T_{switch} correspond to the i-th PUSCH, d_{2,1} is a parameter related to a demodulation-reference signal (DM-RS). For example, if the first symbol of the PUSCH allocation consists of DM-RS only, then d_{2,1}=0, otherwise d_{2,1}=1. d_{2,2} is a BWP switching time. N₂ is selected based on the UE PUSCH processing capability (e.g., PUSCH timing capability) and SCS configuration μ of the i-th PUSCH, where μ corresponds to the smallest SCS configuration among SCS configurations used for the PDCCH scheduling the i-th PUSCH, the PDCCHs scheduling the PDSCHs, or providing the DCI format without scheduling PDSCHs, with corresponding HARQ-ACK information on a PUCCH which is in the group of overlapping PUCCHs/PUSCHs, and all PUSCHs in the group of overlapping PUCCH and PUSCH.

The conditions (e.g., timeline conditions) for UCI multiplexing described above are only examples, and the example embodiments of the disclosure are not limited thereto. Any suitable conditions for UCI multiplexing may be set.

It should be noted that, unless the context clearly indicates otherwise, all or one or more of the methods, steps or operations described in the example embodiments of the disclosure may be specified by protocols and/or configured by higher layer signaling and/or indicated by dynamic signaling. The dynamic signaling may be a PDCCH and/or DCI and/or a DCI format. For example, a SPS PDSCH and/or CG PUSCH may be dynamically indicated in a corresponding activated DCI/DCI format/PDCCH. All or one or more of the described methods, steps and operations may be optional. For example, if a certain parameter (e.g., parameter X) is configured, the UE performs a certain approach (e.g., approach A), otherwise (if the parameter, e.g., parameter X, is not configured), the UE performs another approach (e.g., approach B). Unless otherwise specified, the parameters in the example embodiments of the disclosure may be higher layer parameters. For example, the higher layer parameters may be parameters configured or indicated by higher layer signaling (e.g., RRC signaling).

It should be noted that, a PCell (Primary Cell) or PSCell (Primary Secondary Cell) in the example embodiments of the disclosure may be used interchangeably with a cell having a PUCCH. A serving cell may be used interchangeably with a cell.

It should be noted that, methods for downlink in the example embodiments of the disclosure may also be applicable to uplink, and methods for uplink may also be applicable to downlink. For example, a PDSCH may be replaced with a PUSCH, a SPS PDSCH may be replaced with a CG PUSCH, and downlink symbols may be replaced with uplink symbols, so that methods for downlink may be applicable to uplink.

It should be noted that, methods applicable to scheduling multiple PDSCHs/PUSCHs in the example embodiments of the disclosure may also be applicable to a PDSCH/PUSCH transmission with repetitions. For example, a PDSCH/PUSCH of multiple PDSCHs/PUSCHs may be replaced by a repetition of multiple repetitions of the PDSCH/PUSCH transmission.

It should be noted that in methods of the disclosure, “configured with and/or indicated a transmission with repetitions” may be understood that a number of the repetitions of the transmission is greater than 1. For example, “configured with and/or indicated a PUCCH transmission with repetitions” may be understood that “the PUCCH transmission is repeated on more than one slot/subslot”. “Not configured with and/or indicated a transmission with repetitions” may be understood that a number of the repetitions of the transmission is equal to 1. For example, “not configured with and/or indicated a PUCCH transmission with repetitions” may be understood that “a number of the repetitions of the PUCCH transmission is equal to 1”. For example, the UE may be configured with a parameter

$${N}_{PUCCH}^{repeat}$$

related to a number of repetitions of a PUCCH transmission; when the parameter

$${N}_{PUCCH}^{repeat}$$

is greater than 1, may mean that the UE is configured with a PUCCH transmission with repetitions, and the UE may repeat the PUCCH transmission on

$${N}_{PUCCH}^{repeat}$$

time units (e.g., slots); when the parameter is equal to 1, it may mean that the UE is not configured with a PUCCH transmission with repetitions. For example, the PUCCH transmission with repetitions may include only one type of UCI. If the PUCCH is configured with repetitions, in the example embodiments of the disclosure, a repetition of the multiple repetitions of the PUCCH may be used as a PUCCH (or a PUCCH resource), or all of the repetitions of the PUCCH may be used as a PUCCH (or a PUCCH resource), or a specific repetition of the multiple repetitions of the PUCCH may be used as a PUCCH (or a PUCCH resource).

It should be noted that, in methods of the disclosure, a PDCCH and/or DCI and/or a DCI format schedules multiple PDSCHs/PUSCHs, which may be multiple PDSCHs/PUSCHs on a same serving cell and/or multiple PDSCHs/PUSCHs on different serving cells.

It should be noted that, multiple manners/methods described in the disclosure may be combined in any order. In a combination, a manner/method may be performed one or more times.

It should be noted that, steps/operations of manners/methods of the disclosure may be implemented in any order.

It should be noted that, in the example embodiments of the disclosure, “canceling a transmission” may mean canceling the transmission of the entire uplink channel and/or cancelling the transmission of a part of the uplink channel.

It should be noted that, in the example embodiments of the disclosure, “an order from small to large” (e.g., an ascending order) may be replaced by “an order from large to small” (e.g., a descending order), and/or “an order from large to small” (e.g., a descending order) may be replaced by “an order from small to large” (e.g., an ascending order).

It should be noted that, in the example embodiments of the disclosure, a PUCCH/PUSCH carrying/including/with A may be understood as a PUCCH/PUSCH only carrying/including/with A, and may also be understood as a PUCCH/PUSCH carrying/including/with at least A.

It should be noted that, in the example embodiments of the disclosure, “slot” may be replaced by “subslot” or “time unit”.

It should be noted that, in the example embodiments of the disclosure, “performing a predefined method (or step) if a predefined condition is satisfied” and “not performing the predefined method (or step) if the predefined condition is not satisfied” may be used interchangeably. “Not performing a predefined method (or step) if a predefined condition is satisfied” and “performing the predefined method (or step) if the predefined condition is not satisfied” may be used interchangeably.

It should be noted that in the description of the exemplary embodiments of the disclosure, “configured with a parameter (or information)”, “provided with a parameter (or information)” and “received with a parameter (or information)” may be used interchangeably.

It should be noted that in the description of the exemplary embodiment of the disclosure, “PUCCH with HARQ-ACK information” and “PUCCH including HARQ-ACK information” may be used interchangeably.

It should be noted that in the description of the exemplary embodiments of this disclosure, “HARQ-ACK”, “HARQ-ACK feedback”, “HARQ-ACK information”, “HARQ-ACK information bit(s)” and “HARQ-ACK codebook” may be used interchangeably.

It should be noted that in the description of the exemplary embodiment of the disclosure, “determining HARQ-ACK information bit(s)” and “generating HARQ-ACK information bit(s)” may be used interchangeably.

It should be noted that in the description of the exemplary embodiments of this disclosure, “uplink” and “downlink” may be used interchangeably, “channel”, “channel transmission”, “physical channel” and “physical channel transmission” may be used interchangeably, and “physical channel” and “physical channel resource” may be used interchangeably.

It should be noted that in the description of the exemplary embodiment of the disclosure, two or more physical channels may overlap in time domain and/or in frequency domain.

It should be noted that in the description of the exemplary embodiments of the disclosure, the method applicable to RRC parameters may also be used for MAC CEs, and vice versa.

It should be noted that in the description of the exemplary embodiments of this disclosure, “first and second” and “two” may be used interchangeably. For example, “first channel and second channel” may refer to two channels. In the description of exemplary embodiments of the disclosure, “first and second” may also refer to two or more. For example, “first channel and second channel” may also refer to two or more channels.

It should be noted that in the description of the exemplary embodiment of the disclosure, “serving cell” or “cell” may be “scheduling serving cell” and/or “scheduled serving cell”.

In some cases, the UE may be configured with CG PUSCH resources. For example, a CG PUSCH configuration on an uplink BWP may be configured (for example, in information element (IE) ConfiguredGrantConfig) by higher layer signaling. In addition, one or more CG PUSCH configurations on an uplink BWP may be configured through higher layer signaling (e.g., IE ConfiguredGrantConfigToAddModlist). The UE may be configured one or more CG PUSCH configurations for an uplink BWP corresponding to one or more serving cells. Each of the CG PUSCH configurations may be configured with a CG PUSCH configuration index parameter in a MAC entity (for example, ConfiguredGrantConfigIndexMAC). According to some embodiments of the disclosure, one or more of the methods described below may be adopted for transmitting an uplink channel, for example, a CG PUSCH.

### Method MN1

According to some implementations of Method MN1, the UE may be configured with first information by higher layer signaling. With continued reference to FIG. 7, for example, operation S710 may include that the UE receives the first information. The first information may be used to indicate (e.g., enable) the UE to report fourth information for CG PUSCH configurations in a CG list (e.g., parameter allowedCG-List) allowed for a logical channel, where the fourth information is used to indicate whether CG PUSCH(s) (e.g., CG PUSCH transmission occasion(s) (TO(s))) of the CG PUSCH configuration(s) is (are) unused. For example, the fourth information is used to indicate whether one or more CG PUSCH transmission occasions of a CG configuration (a CG PUSCH configuration) in a CG list (e.g., parameter allowedCG-List) allowed for a logical channel (e.g., allowed for transmission of data of the logical channel) are unused. As an example, the first information may be configured in a logical channel configuration IE (e.g., LogicalChannelConfig). As another example, the first information may be configured in a radio link control (RLC) bearer configuration IE (e.g., RLC-BearerConfig). If the UE receives the first information, the UE may report the fourth information in a CG PUSCH for the CG configurations (CG PUSCH configurations) in the CG list allowed for the logical channel (e.g., allowed for transmission of data of the logical channel). The fourth information may be used to indicate information related to unused CG PUSCHs and/or used CG PUSCHs for the CG PUSCH configuration(s). For example, an unused CG PUSCH may be a CG PUSCH that is unused at the current time or at a time after the current time (in the future).

The UE may also be configured with second information by higher layer signaling. For example, operation S710 may include that the UE receives the second information. The second information is used to indicate information related to determination of CG PUSCH transmission occasions. The second information may be configured in the same way as the first information. For example, the second information may be configured in a logical channel configuration IE (e.g., LogicalChannelConfig), and the second information is used to indicate information related to determination of CG PUSCH transmission occasions for CG PUSCH configurations in a CG list allowed for a logical channel (e.g., allowed for transmission of data of the logical channel). Alter-natively, the second information may also be specified by protocols.

Operation S720 may include that the UE determines third information. For example, the UE may determine the third information according to the first information and/or the second information. For example, the UE (e.g., MAC layer or MAC entity) may transfer the determined third information to a physical layer. The determination of the third information in operation S720 may include, for each of at least one or all CG PUSCH occasions in a first set, determining whether the CG PUSCH occasion is unused. The first set may consist of candidate CG PUSCH occasions (e.g., CG PUSCH occasions (e.g., valid CG PUSCH occasions) for CG PUSCH configuration(s) in a CG list allowed for a logical channel (e.g., allowed for transmission of data of the logical channel)). Or, the determination of the third information in operation S720 may include determining the first (e.g., the earliest) unused CG PUSCH transmission occasion (e.g., the first (e.g., the earliest) unused CG PUSCH transmission occasion for CG PUSCH configurations in a CG list allowed for a logical channel (e.g., allowed for transmission of data of the logical channel) for a period of time), and thus the third information may be the first unused CG PUSCH transmission occasion. The UE may determine the fourth information according to the third information, where the fourth information indicates information related to unused CG PUSCH transmission occasions. For example, in case that the first (e.g., the earliest) unused CG PUSCH transmission occasion is determined, it may be determined that CG PUSCH transmission occasion(s) after the first (e.g., the earliest) unused CG PUSCH transmission occasion is (are) unused.

Operation S730 may include that the UE transmits a CG PUSCH, where the CG PUSCH carries the fourth information. For example, the CG PUSCH is a CG PUSCH for CG PUSCH configurations in the CG list (e.g., parameter allowedCG-List) allowed for the logical channel (e.g., allowed for transmission of data of the logical channel).

By the method, the base station can reallocate CG PUSCH resources that the UE does/will not use based on the fourth information reported by the UE, thereby improving the system spectrum efficiency. In addition, UE may not generate corresponding MAC PDUs for unused CG PUSCH resources, and thus it can avoid generating invalid MAC PDUs, that cannot be retransmitted by HARQ, for data corresponding to the logical channel, thereby improving the uplink transmission performance.

It should be noted that in the example embodiments of the disclosure, “CG PUSCH”, “CG PUSCH transmission occasion”, “CG PUSCH resource”, “CG PUSCH allocation” and “configured uplink grant” may be used interchangeably.

It should be noted that the first information may also be used to indicate (e.g., enable) the UE to report information related to unused CG PUSCHs and/or used CG PUSCHs. For example, the first information may also be used to indicate (e.g., enable) the UE to report information related to unused CG PUSCHs and/or used CG PUSCHs for CG PUSCH configurations in a CG list (e.g., parameter allowedCG-List) allowed for a logical channel (e.g., allowed for transmission of data of the logical channel. For another example, the first information may also be used to indicate (e.g., enable) the UE to report information related to unused CG PUSCHs and/or used CG PUSCHs for a CG PUSCH configuration. In one example, the first information may be used to indicate (e.g., enable) the UE to report a number of transmission occasions of unused CG PUSCHs and/or used CG PUSCHs for a CG PUSCH configuration. In another example, the first information may be used to indicate (e.g., enable) the UE to report a number of bits of transmission occasions of unused CG PUSCHs and/or used CG PUSCHs for a CG PUSCH configuration.

It should be noted that the first information and/or the second information may be indicated by a higher layer parameter.

### Method MN2

According to some implementations of Method MN2, the second information may indicate information related to a MAC CE and/or other logical channels included in a CG PUSCH (e.g., other logical channels may be different logical channels associated with or corresponding to the CG PUSCH).

For example, the second information may indicate at least one of:
whether a MAC CE can be (e.g., be allowed to be) multiplexed in a CG PUSCH transmission. That is, whether a MAC CE may be included in a CG PUSCH.
whether a MAC CE can be (e.g., be allowed to be) multiplexed in a predefined CG PUSCH transmission. The predefined CG PUSCH transmission may be a CG PUSCH transmission other than the first CG PUSCH transmission. The first CG PUSCH transmission may be the first CG PUSCH transmission in a predefined time (e.g., a period).
information regarding a number of MAC CEs that can be (e.g., be allowed to be) included in a CG PUSCH. For example, a maximum number of MAC CEs that can be included in a CG PUSCH.
whether data of other logical channels can be (e.g., be allowed to be) multiplexed in a CG PUSCH transmission.
whether data of other logical channels can be (e.g., be allowed to be) multiplexed in the predefined CG PUSCH transmission.
information regarding data of other logical channels that can be (e.g., be allowed to be) included in a CG PUSCH. For example, a maximum value of data of other logical channels that can be (e.g., be allowed to be) included in a CG PUSCH.

The method can accurately determine a number of CG PUSCHs needed for transmission, and can avoid changing the number of CG PUSCH transmission occasions needed for time slots by new MAC CE data after the UE determines unused CG PUSCH transmission occasions, thereby improving the uplink transmission reliability.

### Method MN3

According to some implementations of Method MN3, the UE may determine the first set according to at least one of the following:
fifth information. The fifth information is used to indicate information related to CG PUSCH transmission occasions that need to be determined whether they are used for CG PUSCH configurations. For example, the CG PUSCH configuration may be a CG PUSCH configuration in a CG list (e.g., parameter allowedCG-List) allowed for a logical channel (e.g., allowed for transmission of data of the logical channel). In some implementations, the fifth information may indicate a number of periods (or numbers of CG PUSCH transmission occasions) of a CG PUSCH configuration. Or, the fifth information may indicate an absolute length of time. Or, the fifth information may indicate a period of a packet of a logical channel. For example, the fifth information may be configured by higher layer signaling or specified by protocols. For example, the configuration is performed by the configuration method of the first information in the example embodiments of the disclosure.
arrival time of a packet (e.g. RLC SDU) of a logical channel. For example, arrival time of the last packet.
first time information T1. The first time information T1 is used to indicate a time interval between a first CG PUSCH transmission occasion (e.g., the earliest CG PUSCH transmission occasion) (e.g., the CG PUSCH transmission occasion including a packet of a logical channel (e.g., in a period of the logical channel)) and the first one (e.g., the earliest one) in the first set. The first time information may be configured by higher layer signaling or specified by protocols. The unit of T1 may be absolute time, for example, T1 is in units of milliseconds; T1 may also be in units of slots or symbols. T1 may be a rational number.

In an example, after a MAC entity receives a packet of a logical channel, it may generate a MAC PDU in a CG PUSCH transmission occasion for CG PUSCH transmission configurations in a CG list (e.g., parameter allowedCG-List) allowed for a logical channel (e.g., allowed for transmission of data of the logical channel). The first set may be N CG PUSCH transmission occasions after the CG PUSCH transmission occasion. N may be an integer, and/or N may be indicated by the fifth information. Or, the first set may be N CG PUSCH transmission occasions after the time T1 after the CG PUSCH transmission occasion (e.g., as indicated by the first time information T1 as described above).

### Method MN4

According to some implementations of Method MN4, the UE may determine the first unused CG PUSCH transmission occasion according to at least one of the following:
sixth information. The sixth information is used to indicate information related to an amount of data of a logical channel. The sixth information may be transmitted by a higher layer to a MAC layer. After the MAC layer (or MAC entity) receives the sixth information, the UE may determine a size of a packet of the logical channel within a period of time and/or whether a packet of the logical channel within a period of time has arrived. For example, the sixth information may include one of the following:
the size of the packet of the logical channel;
information related to the last packet of the logical channel; for example, the size of the last packet; for another example, the arrival time of the last packet. The last packet may be the last packet within a period of time (e.g., a period (e.g., the period of the logical channel)).
second time information T2. The second time information is used to indicate a time interval (e.g., the maximum (or minimum) of the time interval) between the first CG PUSCH transmission occasion (the first CG PUSCH transmission occasion including the packet of the logical channel) and the first unused CG PUSCH transmission occasion. The second time information may be configured by higher layer signaling or specified by protocols. The unit of T2 may be absolute time, for example, T2 is in units of milliseconds; T2 may also be in units of slots or symbols. T2 may be a rational number.
seventh information. The seventh information is used to indicate a number (e.g., the maximum (or minimum) number) of CG PUSCH transmission occasions between the first CG PUSCH transmission occasion (e.g., the earliest CG PUSCH transmission occasion) (e.g., the first CG PUSCH transmission occasion including the packet of the logical channel (within the period of the logical channel)) and the first unused CG PUSCH transmission occasion (the earliest unused CG PUSCH transmission occasion). For example, the seventh information may be configured by higher layer signaling or specified by protocols. For example, the configuration is performed by the configuration method of the first information in the example embodiments of the disclosure.
information related to a MAC CE; for example, a size of a MAC CE that can be transmitted by a CG PUSCH.
second information. The second information may be used to indicate information related to a MAC CE included in a CG PUSCH. For example, the second information may be used to indicate whether a MAC CE can be transmitted through a CG PUSCH. For another example, the second information may be used to indicate information about a number (e.g., the maximum number) of MAC CEs that can be included in a CG PUSCH. The second information may be configured by higher layer signaling. The details about the second information may refer to the description of Method MN2.
at least one of time domain resource allocation information, frequency domain resource allocation information, a resource block group (RBG) size, a MCS table, and MCS and transport block size (TBS) related information for a CG PUSCH configuration.
information related to a TBS for a CG PUSCH configuration, such as a size of a MAC PDU that can be carried by a CG PUSCH transmission occasion.
a number of repetitions of a CG PUSCH transmission (e.g., parameter repK).
a number of CG PUSCH transmission occasions within a CG PUSCH period.
a configured grant timer associated with a HARQ process for a CG PUSCH configuration (e.g., parameter configuredGrantTimer).
available CG PUSCH transmission occasions. The available CG PUSCH transmission occasions may be CG PUSCH transmission occasions that can be transmitted, that is, non-unavailable CG PUSCH transmission occasions. For example, if a CG PUSCH transmission occasion overlaps with a first predefined symbol, the CG PUSCH transmission occasion is an unavailable CG PUSCH transmission occasion. For another example, if a CG PUSCH transmission occasion overlaps with a PDCCH or a PUSCH scheduled by DCI (or PDCCH), the CG PUSCH transmission occasion is an unavailable CG PUSCH transmission occasion. For another example, if the configured grant timer (e.g., parameter configuredGrantTimer) of a HARQ process corresponding to a CG PUSCH transmission occasion is still running in the starting symbol (or location) of the CG PUSCH transmission occasion, the CG PUSCH transmission occasion is an unavailable CG PUSCH transmission occasion.

For example, the first predefined symbol may be at least one of the following:
downlink symbols by semi-static configuration (configured by higher layer signaling) (e.g., downlink symbols configured by the 3GPP parameter tdd-UL-DL-ConfigurationCommon or tdd-UL-DL-ConfigurationDedicated).
symbols of a SSB (synchronization signal block).
symbols for CORESET0. For example, CORESET associated with the type 0-PDC public search space (CSS) set.
unavailable symbols configured by higher layer signaling.
X symbols after a SSB. Where X is a positive integer or a positive rational number, which may be specified by protocols and/or configured by higher layer signaling.

In an example, assuming that a size of a packet of a logical channel is X and a size of a MAC PDU that can be carried by a CG PUSCH transmission occasion is Y, a number of packets for transmission of the logical channel may be ceil(X/Y), where ceil ( ) is an upper bound function. Then, ceil(X/Y) available CG PUSCH transmission occasions may be determined, and the next CG PUSCH transmission occasion or the next available CG PUSCH transmission occasion after the last CG PUSCH transmission occasion determined for the transmission is the first unused CG PUSCH transmission occasion. If the second information configures the maximum value of the number of MAC CEs that can be included in the CG PUSCH as Z, the number of packets for transmission of the logical channel may be ceil((X+Z)/Y).

It should be noted that the second information may also be determined according to the number of CG PUSCH transmission occasions for transmission. For example, in the above example, the second information may be determined as Z×ceil(X/Y) (or, Z×X/Y), and the number of packets for transmission of the logical channel may be:
ceil((X+Z×ceil(X/Y))/Y) (or, ceil((X+Z×X/Y)/Y)).

According to an embodiment, it may be specified by protocols that if the first information is configured in a logical channel configuration parameter, the number of CG PUSCH configurations in the CG list (e.g., parameter allowedCG-List) allowed for the logical channel is a specified number (e.g., 1). The method can reduce the complexity of UE implementation.

According to an embodiment, it may be specified by protocols that if the first information is configured in a logical channel configuration parameter, the number of CG PUSCH configurations, on the same serving cell, in the CG list allowed for the logical channel (e.g., parameter allowedCG-List) is a specified number (e.g., 1). The method can reduce the transmission latency of uplink data.

According to an embodiment, it may be specified by protocols that if the first information is configured in a logical channel configuration parameter, the CG PUSCH configurations in the CG list (e.g., parameter allowedCG-List) allowed for the logical channel are not configured in the CG list allowed for another logical channel (e.g., allowed for transmission). The method can reduce the complexity of UE implementation.

According to an embodiment, it may be specified by protocols that the first information and the repetitions of the CG PUSCH transmission cannot be configured simultaneously. Or, if the first information is configured, it is considered that the CG PUSCH is not transmitted with repetitions. The method can reduce the complexity of implementation.

According to an embodiment, if the transmission with repetitions is configured for the CG PUSCH, the CG PUSCH occasion indicated by the second information is the first CG PUSCH occasion of the repetitions of the CG PUSCH transmission. The method can improve the indicating efficiency of the second information.

### Method MN5

In some cases, a CG PUSCH transmission occasion may be indicated as unused by fourth information. For example, the fourth information may be unused transmission occasion-UCI (UTO-UCI). If a CG PUSCH transmission occasion is indicated as unused by the fourth information, the UE may consider (or assume) that the CG PUSCH transmission occasion or resources (e.g., time domain resources and/or frequency domain resources) corresponding to the CG PUSCH transmission occasion are not configured. That is, the UE may consider (or assume) that the CG PUSCH transmission occasion does not exist. Or, the CG PUSCH transmission occasion or an uplink grant corresponding to the CG PUSCH transmission occasion is regarded as a de-prioritized CG PUSCH or uplink grant.

In one example, when resolving (or determining) the overlapping among PUCCH(s) and PUSCH(s) or the overlapping among multiple PUSCHs, the UE excludes CG PUSCH(s) indicated by the fourth information as unused (e.g., the indication of the UTO-UCI is 1). For the excluded CG PUSCH indicated by the fourth information as unused (e.g., the indication of the UTO-UCI is 1), the timing condition does not need to be satisfied, or the timing condition may not be satisfied. The timing conditions may be the timing conditions defined in the embodiments of the disclosure.

In one example, when resolving (or determining) the overlapping among PDSCH(s) (e.g., PDSCH scheduled by a DCI format) and CG PUSCH(s), the UE excludes CG PUSCH(s) indicated by the fourth information as unused (e.g., the indication of the UTO-UCI is 1). For the excluded CG PUSCH indicated by the fourth information as unused (e.g., UTO-UCI indicates 1), the timing condition does not need to be satisfied, or the timing condition may not be satisfied. The timing conditions may be the timing conditions defined in the embodiments of the disclosure.

The method reduces the scheduling latency because it does not need to meet the timing conditions, thereby improving the scheduling flexibility. The method can also avoid multiplexing UCI in a CG PUSCH indicated by the fourth information as unused, which can improve the reliability of UCI transmission.

### Method MN6

For a MAC entity configured with a logical channel-based prioritization parameter (e.g., parameter lch-basedPrioritization), if a configured uplink grant (e.g., CG PUSCH) is indicated as unused by the fourth information, or is determined as unused, the configured uplink grant is regarded as a de-prioritized uplink grant. The method cans increase the transmission opportunity of an uplink channel overlapping with the configured uplink grant, thereby reducing the uplink transmission latency.

In an example, when determining whether to trigger a buffer status report (BSR) or SR, a configured uplink grant (e.g., CG PUSCH) indicated by the fourth information as unused or a configured uplink grant determined as unused may not be considered, which can increase the probability that the BSR or SR is triggered, thereby reducing the transmission latency of the SR.

FIG. 10 illustrates a flowchart of a method 1000 performed by a terminal according to some embodiments of the disclosure.

Referring to FIG. 10, in operation S1010, the terminal receives second information, where the second information is used to indicate information related to CG PUSCH transmission occasions. Examples of the first information may refer to the descriptions in Methods MN1-MN4.

According to an embodiment, in operation S1020, the terminal determines third information based on the second information, where the third information includes whether one or more CG PUSCH transmission occasions are unused.

According to an embodiment, in operation S1030, the terminal transmits a CG PUSCH with fourth information, where the fourth information indicates information related to unused CG PUSCH transmission occasions among the one or more CG PUSCH transmission occasions.

According to an embodiment, one or more of operations S1010 to S1030 may be performed based on the methods described according to various embodiments of the disclosure (e.g., the embodiments described in connection with FIGS. 4-7, and various methods described above, such as Methods MN1-MN4).

According to an embodiment, the method 1000 may omit one or more of operations S1010 to S1030, or may include additional operations, for example, the operations described by a terminal (e.g., a UE) according to various embodiments of the disclosure (e.g., the embodiments described in connection with FIGS. 4-7, and various methods described above, such as Methods MN1-MN4).

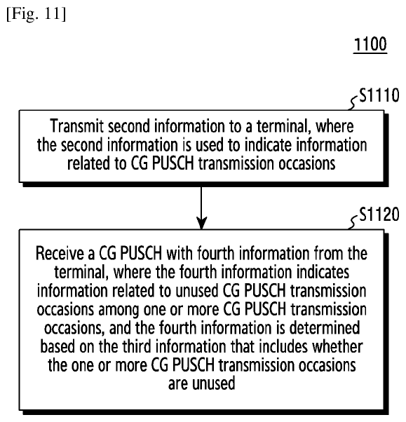

FIG. 11 illustrates a flowchart of a method 1100 performed by a base station according to some embodiments of the disclosure.

Referring to FIG. 11, in operation S1110, the base station transmits second information to a terminal, where the second information is used to indicate information related to CG PUSCH transmission occasions. Examples of the first information may refer to the descriptions in Methods MN1-MN4.

According to an embodiment, in operation S1120, the base station receives a CG PUSCH with fourth information from the terminal, where the fourth information indicates information related to unused CG PUSCH transmission occasions among one or more CG PUSCH transmission occasions, and the fourth information is determined based on the third information that includes whether the one or more CG PUSCH transmission occasions are unused.

According to an embodiment, one or more of operations S1110 to S1120 may be performed based on the methods described according to various embodiments of the disclosure (e.g., the embodiments described in connection with FIGS. 4-7, and various methods described above, such as Methods MN1-MN4).

According to an embodiment, the method 1100 may omit one or more of operations S1110 to S1120, or may include additional operations, such as those described by the base station according to various embodiments of the disclosure (e.g., the embodiments described in connection with FIGS. 4-7, and various methods described above, such as Methods MN1-MN4).

Those skilled in the art will understand that the above illustrative embodiments are described herein and are not intended to be limiting. It should be understood that any two or more of the embodiments disclosed herein may be combined in any combination. Furthermore, other embodiments may be utilized and other changes may be made without departing from the spirit and scope of the subject matter presented herein. It will be readily understood that aspects of the invention of the disclosure as generally described herein and shown in the drawings may be arranged, replaced, combined, separated and designed in various different configurations, all of which are contemplated herein.

Those skilled in the art will understand that the various illustrative logic blocks, modules, circuits, and steps described in this application may be implemented as hardware, software, or a combination of both. To clearly illustrate this inter-changeability between hardware and software, various illustrative components, blocks, modules, circuits, and steps are generally described above in the form of their functional sets. Whether such function sets are implemented as hardware or software depends on the specific application and the design constraints imposed on the overall system. Technicians may implement the described function sets in different ways for each specific application, but such design decisions should not be interpreted as causing a departure from the scope of this application.

The various illustrative logic blocks, modules, and circuits described in this application may be implemented or performed by a general purpose processor, a Digital Signal Processor (DSP), an Application Specific Integrated Circuit (ASIC), a Field Programmable Gate Array (FPGA) or other programmable logic devices, discrete gates or transistor logics, discrete hardware components, or any combination thereof designed to perform the functions described herein. The general purpose processor may be a microprocessor, but in an alternative, the processor may be any conventional processor, controller, microcontroller, or state machine. The processor may also be implemented as a combination of computing devices, such as a combination of a DSP and a microprocessor, a plurality of microprocessors, one or more microprocessors co-operating with a DSP core, or any other such configuration.

The steps of the method or algorithm described in this application may be embodied directly in hardware, in a software module executed by a processor, or in a combination thereof. The software module may reside in a RAM memory, a flash memory, a ROM memory, an EPROM memory, an EEPROM memory, a register, a hard disk, a removable disk, or any other form of storage medium known in the art. An exemplary storage medium is coupled to a processor to enable the processor to read and write information from/to the storage medium. In an alternative, the storage medium may be integrated into the processor. The processor and the storage medium may reside in an ASIC. The ASIC may reside in a communication apparatus (e.g., a terminal or a base station). In an alternative, the processor and the storage medium may reside in a communication apparatus (e.g., a terminal or a base station) as discrete components.

In one or more exemplary designs, the functions may be implemented in hardware, software, firmware, or any combination thereof. If implemented in software, each function may be stored as one or more pieces of instructions or codes on a computer-readable medium or delivered through it. The computer-readable medium includes both a computer storage medium and a communication medium, the latter including any medium that facilitates the transfer of computer programs from one place to another. The storage medium may be any available medium that may be accessed by a general purpose or special purpose computer.

The above description is only an exemplary implementation of the present invention, and is not intended to limit the scope of protection of the present invention, which is determined by the appended claims.

1-15. (canceled)

16. A method performed by a user equipment (UE), the method comprising:
receiving, from a base station, configuration information on a configured grant (CG) physical uplink shared channel (PUSCH), wherein the configuration information includes first information enabling second information on an unused transmission occasion (UTO) of the CG PUSCH;
determining whether a configured uplink grant within transmission occasions (TOs) associated with the configuration information is to be used for the CG PUSCH based on the first information; and
transmitting, to the base station, a report including the second information on the UTO based on the determination.

17. The method of claim 16, wherein the determination is performed via a medium access control (MAC) entity of the UE, and
wherein information associated with the determination is sent from the MAC entity to a physical layer of the UE for the report.

18. The method of claim 16, wherein the second information indicates whether a CG PUSCH is transmitted or not in a corresponding TO.

19. The method of claim 16, wherein the report including the second information is transmitted to the base station in a CG PUSCH.

20. The method of claim 16, wherein a medium access control (MAC) protocol data unit (PDU) is not generated for a TO in which the CG PUSCH is not transmitted.

21. The method of claim 20, wherein resources associated with the TO in which the CG PUSCH is not transmitted are reallocated based on the second information.

22. The method of claim 16, wherein the determination is performed for each TO in order, and
wherein the configuration information is received from the base station via a higher layer signalling.

23. A user equipment (UE) comprising:
at least one transceiver;
at least one processor communicatively coupled to the at least one transceiver; and
at least one memory, communicatively coupled to the at least one processor, storing instructions executable by the at least one processor individually or in any combination to cause the UE to:
receive, from a base station, configuration information on a configured grant (CG) physical uplink shared channel (PUSCH), wherein the configuration information includes first information enabling second information on an unused transmission occasion (UTO) of the CG PUSCH,
determine whether a configured uplink grant within transmission occasions (TOs) associated with the configuration information is to be used for the CG PUSCH based on the first information, and
transmit, to the base station, a report including the second information on the UTO based on the determination.

24. The UE of claim 23, wherein the determination is performed via a medium access control (MAC) entity of the UE, and
wherein information associated with the determination is sent from the MAC entity to a physical layer of the UE for the report.

25. The UE of claim 23, wherein the second information indicates whether a CG PUSCH is transmitted or not in a corresponding TO.

26. The UE of claim 23, wherein the report including the second information is transmitted to the base station in a CG PUSCH.

27. The UE of claim 23, wherein a medium access control (MAC) protocol data unit (PDU) is not generated for a TO in which the CG PUSCH is not transmitted.

28. The UE of claim 27, wherein resources associated with the TO in which the CG PUSCH is not transmitted are reallocated based on the second information.

29. The UE of claim 23, wherein the determination is performed for each TO in order, and
wherein the configuration information is received from the base station via a higher layer signalling.

30. One or more non-transitory computer-readable storage media storing computer-executable instructions that, when executed by at least one processor of a user equipment (UE) individually or collectively, cause the UE to perform operations, the operations comprising:
receiving, from a base station, configuration information on a configured grant (CG) physical uplink shared channel (PUSCH), wherein the configuration information includes first information enabling second information on an unused transmission occasion (UTO) of the CG PUSCH;
determining whether a configured uplink grant within transmission occasions (TOs) associated with the configuration information is to be used for the CG PUSCH based on the first information; and
transmitting, to the base station, a report including the second information on the UTO based on the determination.
